(19) United States
(12) Patent Application Publication
(10) Pub. No.: US 2012/0272134 A1
(43) Pub. Date: Oct. 25, 2012

(54) APPARATUS, SYSTEM AND METHOD FOR A MEDIA ENHANCEMENT WIDGET

(76) Inventors: Chad Steelberg, Newport Beach, CA (US); Ryan Steelberg, Irvine, CA (US)

(21) Appl. No.: 13/430,169

(22) Filed: Mar. 26, 2012

Related U.S. Application Data
(63) Continuation-in-part of application No. 13/425,960, filed on Mar. 21, 2012.
Application No. 13/425,960 is a continuation-in-part of application No. 12/144,194, filed on Jun. 23, 2008.
Application No. 12/144,194 is a continuation-in-part of application No. 11/981,646, filed on Oct. 31, 2007.
Application No. 11/981,646 is a continuation-in-part of application No. 10/072,692, filed on Feb. 6, 2002, now abandoned.
(60) Provisional application No. 61/467,591, filed on Mar. 25, 2011.
(60) Provisional application No. 60/993,096, filed on Sep. 7, 2007.

(51) Int. Cl. G06F 17/00

(52) U.S. Cl. 715/234

(57) ABSTRACT

The present invention is and includes a device, system and method for providing an image enhancement widget. The device, system and method include a javascript component that, upon execution, obtains at least one subject of primary content on a networked page, and at least one permission for enhancement of the primary content, ones of a plurality of content produced remotely from the javascript component and according to the javascript component, and an enhancement widget. The enhancement widget may be a flash widget.

### CROSS-REFERENCE TO RELATED APPLICATION

This application claims priority to U.S. Provisional Patent Application Ser. No. 61/467,591, filed Mar. 25, 2011, entitled Apparatus, System and Method for a Media Enhancement Widget and is a continuation-in-part of U.S. patent application Ser. No. 13/425,960, entitled “System and Method for Brand Affinity Content Distribution and Optimization”, filed Mar. 21, 2012, the entireties of which are expressly incorporated herein by reference in their entireties.

U.S. patent application Ser. No. 13/425,960 is a continuation-in-part of U.S. patent application Ser. No. 12/144,194, entitled “System and Method for Brand Affinity Content Distribution and Optimization”, filed Jun. 23, 2008, which is: a continuation-in-part of U.S. patent application Ser. No. 11/981,646, entitled “Engine, System and Method for Generation of Brand Affinity Content”, filed Oct. 31, 2007, which is: related to co-filed U.S. patent application Ser. No. 11/981,837, entitled “An Advertising Request And Rules-Based Content Provision Engine, System and Method”, filed Oct. 31, 2007, and which claims priority to U.S. Provisional Application Ser. No. 60/993,096, entitled “System and Method for Rule Based Generation of Brand Affinity Content,” filed Sep. 7, 2007; and is a continuation-in-part of U.S. patent application Ser. No. 10/072,692, entitled “Engine, System and Method For Generation of Brand Affinity Content, filed Feb. 27, 2008; and a continuation in part of U.S. patent application Ser. No. 12/079,769, entitled “Engine, System and Method for Generation of Brand Affinity Content,” filed Mar. 27, 2008, also related to the aforementioned co-filed U.S. Ser. No. 12/072,692, and which is a continuation-in-part of U.S. patent application Ser. No. 12/042,913, entitled “Engine, System and Method for Generation of Brand Affinity Content,” filed Mar. 5, 2008; and claims priority to U.S. Provisional Patent Application Ser. No. 61/065,297, entitled “System and method of Assessing Quantitative and Qualitative Use of a Brand,” filed Feb. 7, 2008; and claims priority to U.S. Provisional Patent Application Ser. No. 61/131,386, entitled “Apparatus, System and Method for a Brand Affinity Engine Using Positive and Negative Mentions”, filed Jul. 29, 2008; each of which applications are hereby incorporated by reference herein as if set forth in the entirety.

### BACKGROUND OF THE INVENTION

1. Field of the Invention

The present invention is directed to media enhancement and, more particularly, to an apparatus, system and method for a media enhancement widget.

2. Description of the Background

In typical current advertising embodiments, although sponsorship and promotional media is an 80 billion dollar industry in the United States, very little sponsorship and promotional advertising is engaged in “on-line,” that is, in networked telecommunications environments such as Internet, extranet, intranet, satellite, wired, wireless, including ad-hoc wireless, and similar communication networks, which employ computers, personal digital assistants, conference phones, cellular telephones and the like. In fact, it its estimated that only 250 million dollars in on-line advertising using sponsorship and promotional material is made available in the United States, or 0.31% of the aforementioned 80 billion dollar industry.

Further, the inefficiencies of obtaining sponsorship and promotional spots in advertising drastically limit the universe of available sponsors and promoters, at least in that, if procurement of a brand can take several months, it stands to reason that advertisers will endeavor to obtain only those sponsors that the advertisers can be assured will have a positive public image and likeability over the course of many months. Needless to say, this drastically limits the universe of available sponsors. For example, it is estimated that, in the multi-billion dollar athletic sponsorship advertising industry, 95% of sponsorship dollars are spent hiring the top 5% of athletes to become sponsors. As such, very few sponsorships are made available by the prior art to less desirable athletes, although such athletes may be less desirable for any of a number of reasons, at least some of which reasons are unrelated to likeability or negative image. For example, a baseball player may be a perennial all-star, but may play in a “small market,” and as such may not be deemed to fall within the top 5% of athlete-sponsors. Consequently, although the exemplary player may be very popular in certain areas or with certain demographics, in the prior art it is very unlikely this particular exemplary athlete will obtain much in the way of sponsorships.

Needless to say, the typically lengthy mechanism that precludes sponsorship from occurring on-line thus, as discussed above, drastically limits the available universe of sponsors. Further, such current mechanisms fail to take into account that certain sponsors may have a willingness to engage in certain sponsorships at certain times, with respect to certain products, in certain geographic locales, or in certain editorial or social contexts, or may be desired as sponsors at certain times, or only in certain geographic locales, or only with regard to certain products, or only in editorial or social contexts.

For example, in the sponsorship industry, it is well established that famous actors in the United States may market products internationally that they do not wish to lend sponsorship to in the United States. Additionally, because news with regard to United States athletes or actors, for example, may break more quickly in the United States, those same athletes or actors may experience a lengthened time of availability for desirable sponsorship in other countries. For example, a baseball player may come to be suspected of steroid use in the United States, thereby limiting his desirability as a sponsor for products in the United States, but may nonetheless continue to be popular in Japan until or if such steroid use is definitively proven. Thereby, an inability to efficiently provide for that baseball player to become a sponsor in Japan, where that baseball player may not normally allow for his likeness to be used in sponsorship, may seriously curtail sponsorship opportunities for that baseball player, as well as curtailing advertising possibilities for Japanese advertisers.

Thus, the need exists for an apparatus, system and method to allow for assessment of optimal sponsors for particular markets, in particular geographies, and in particular contexts, and that provides increased sponsorship and advertising opportunities.

### SUMMARY OF THE INVENTION

The present invention is and includes a device, system and method for providing an image enhancement widget. The device, system and method include a javascript component that, upon execution, obtains at least one subject of primary content on a networked page, and at least one permission for enhancement of the primary content, ones of a plurality of content produced remotely from the javascript component and according to the javascript component, and an enhancement widget. The enhancement widget may be a flash widget, and may include ones of the plurality of content overlayed upon the primary content to provide a permitted enhancement of the primary content on the networked page. The enhancement widget may preferably provide the enhancement without obscuring at least other than the primary content of the networked page.

Thus, the present invention provides an apparatus, system and method to allow for assessment of optimal sponsors for particular markets, in particular geographies, and in particular contexts, and that provides increased sponsorship and advertising opportunities.

### BRIEF DESCRIPTION OF THE DRAWINGS

Understanding of the disclosure will be facilitated by consideration of the following detailed description of the embodiments, taken in conjunction with the accompanying drawings, in which like numerals refer to like parts and in which:

FIG. 1 is a block diagram that illustrates the system of engines in accordance with the present invention;

FIG. 2 is a block diagram that illustrates a metrics engine in accordance with the present invention;

FIG. 3 is a block diagram illustrating components of an enhancement widget in accordance with the present invention; and

FIG. 4 is an illustration of an enhancement widget in accordance with the present invention;

FIG. 5 is an illustration of an enhancement widget in accordance with the present invention;

FIG. 6 is an illustration of an enhancement widget in accordance with the present invention;

FIG. 7 is an illustration of an enhancement widget in accordance with the present invention;

FIG. 8 is an illustration of an enhancement widget in accordance with the present invention;

FIG. 9 is an illustration of an enhancement widget in accordance with the present invention;

FIG. 10 is an illustration of an enhancement widget in accordance with the present invention;

FIG. 11 is an illustration of an enhancement widget in accordance with the present invention;

FIG. 12 is an illustration of an enhancement widget in accordance with the present invention;

FIG. 13 is an illustration of an enhancement widget in accordance with the present invention; and

FIGS. 14-29 are an illustration of an enhancement widget in accordance with the present invention.

### DETAILED DESCRIPTION OF THE INVENTION

It is to be understood that the figures and descriptions of the present invention have been simplified to illustrate elements that are relevant for a clear understanding of the present invention, while eliminating, for the purposes of clarity, many other elements found in typical computing apparatuses, systems and methods. Those of ordinary skill in the art will recognize that other elements are desirable and/or required in order to implement the present invention. However, because such elements are well known in the art, and because they do not facilitate a better understanding of the present invention, a discussion of such elements is not provided herein.

Further, the elements and actions discussed herein may preferably be embodied in computing hardware, and may be operable over one or more computing networks, such as at one or more nodes of a computing network. Thus, aspects of the present invention may be associated with one or more computer storage mechanisms, and may be executed by one or more computing processors.

It is generally accepted that advertising and/or creative (hereinafter referred to as “ad,” “creative,” or “content”) having the highest impact on the desired consumer base includes endorsements, sponsorships, or affiliations from those persons, entities, or the like from whom the targeted consumers seek guidance, or about whom the target customers seek news. As such, the desirability of providing content, such as an ad or content enhancement, associated with a particular talent may be based on the endorser's knowledge of particular goods or in a particular industry, the fame of the endorser, the respect typically accorded a particular endorser or sponsor, the use of the endorser in association with news, gossip, or the like, and other similar factors. As used herein, such content may be provided, for example, in association with content regarding a particular good or service, an actor, actress, an athlete, a famous person, a subject of an artistic, audio, visual, and/or audiovisual work, and/or an actual endorsement of the use of a product.

At present, there is a need for a platform or engine to allow for the querying, such as a searching and/or requesting, for content associated with a talent or brand, the return, responsive to a search and/or responsive to a recommendation, either manually or automatically, of content responsive to the query, and the fulfillment or delivery of the content, such as in association with other primary content. In a preferred embodiment, the delivery of the content may be in the form of, for example, a widget that serves to provide additional content that enhances the primary content.

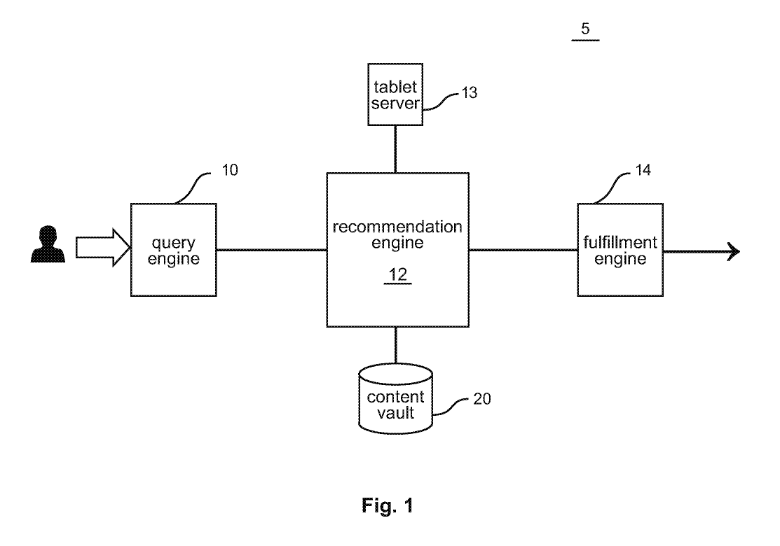

More specifically, and as illustrated in FIG. 1, the system 5 of the present invention may provide a query engine 10, whereby a user may inquire, such as by a search or request, for talent fitting certain categories, and/or for content associated with particular talent. The present invention may further provide a recommendation engine 12, which may be and/or include a server 13, such as a talent server, wherein the recommendation engine returns results responsive to the inquiry entered via query engine 10. Finally, a fulfillment engine 14 may enable the content for delivery, such as preparing the content returned by recommendation engine in a particular template, format, widget, or the like.

Thus, query engine 10 may be a search interface, a list interface, a series of selectable drop downs, a request for enhancement received from a third party site, or the like. Recommendation engine 12 may include, and/or have accessible thereto, a content vault 20, having resident therein a plurality of content categorically associated with, or associated on a one-to-one basis with, talent and brands. For example, content in the vault may include text, such as quotes, audio, video, pictures, highlights, or the like, and such content may have limited availability categorized by time, location, product, context, service, or the like. The recommendation engine may additionally generate and/or accumulate metrics, such as for association with talent in the vault, and therefore may issue scores, rankings, or the like.

The fulfillment engine 14 may provide one or more templates for the creation of sponsored advertisements, or for the association of content with other, primary content, and may thus provide content for delivery, such as from the content vault. The fulfillment engine may, based on direct or redirect delivery, deliver the content. The fulfillment engine may formulate, or may direct the formulation at a third party site, the content into a widget enhancement for third party content, as discussed further hereinthroughout.

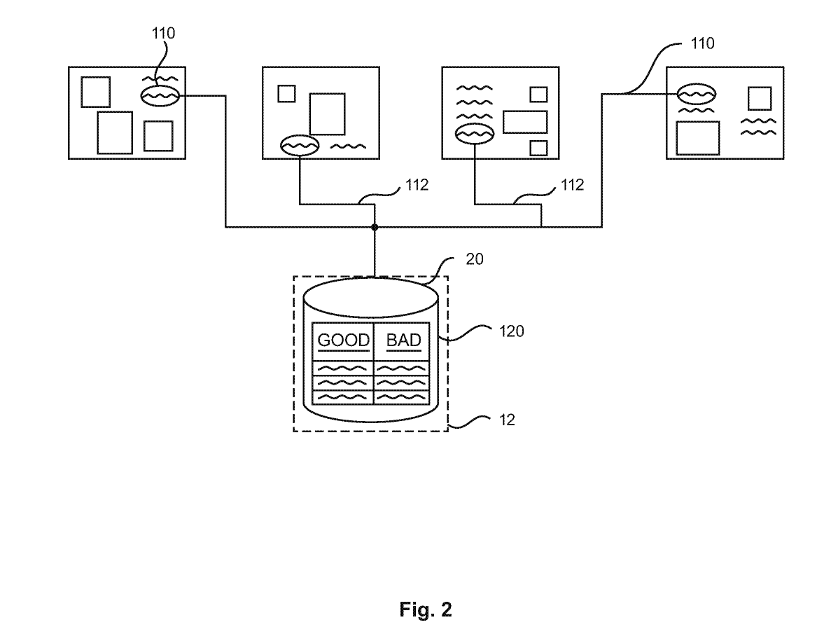

As referenced hereinabove, the recommendation engine may provide metrics for sponsoring brands and talent. Such metrics may be gauged in any number of ways, certain of which will be apparent to those skilled in the art in light of the disclosure herein. For example, as illustrated in FIG. 2, positive 110 and negative 112 mentions of brands 114 may be tracked, such as by comparison of those brands with predetermined sets and/or subsets of “good” and “bad” keywords 120 for association with those sponsoring brands. Thereby, valuation may be assigned to certain keywords in the present invention, and the value of certain sponsoring brands may be tracked, based on association with those keywords, over time, in certain geographies, in certain markets, in certain contexts, and/or with regard to certain products or services, and the like. Keywords may, of course, be “good” to be associated with, meaning such keywords are indicative of positive associations with the sponsoring brand, “bad” to be associated with, meaning such keywords are indicative of negative associations with the sponsoring brand, or “neutral.”

In an exemplary embodiment of the present invention, a football player is mentioned in association with a particular keyword. The keyword association may be assigned a +1 to +10 rating for a positive keyword associative mention, or a −1 to a −10 rating for a negative keyword association. Additionally, if the associated keyword is flagged for association with the sponsoring brand searched, but in actuality does not apply for any one of a number of reasons, such as an unreliable source or an actual reference to a different party, the association may be marked with a N/A, for example. Such associations and keyword rating of mentions may be performed automatically, or, upon flagging of a particular sponsorship brand, may be performed manually. Manual searchers may, needless to say, receive training in order to use consistent numerical ratings for associative mentions. Further, manual searchers may receive retraining such as wherein, for example, 100 searchers rated a particular mention or series of mentions as a +5. In such a case, such mentions or similar mentions may be repeatedly re-routed to a particular searcher-in-trainer until that searcher in training begins to rate such mentions within a predetermined acceptable variation of +5.

Thereby, a brand or talent may have associated therewith a “heat index,” wherein the greater the total positive rating for all keywords tracked in all markets tracked may constitute how “hot” a sponsor is globally, and similarly a total negative rating would track how “cold” a particular sponsoring brand was. This heat index may, for example, be or become part of a widget enhancement. Needless to say, the above is exemplary in nature only, and similarly tracking could occur not only on a positive or negative association basis, but additionally on a geographic, product, service, context, or other basis. For example, the aforementioned “hot” and “cold” rating system may be used to draw a geographic “heat map,” wherein the rating of a sponsoring brand in particular geographic markets may be laid out on a map illustrating the hotness or coldness of the sponsoring brand uniquely in each geographic market tracked.

By way of example, the enhancement widget may be provided for association with a reference to a particular subject of interest, and such widget may provide, for example, metrics associated with that subject of interest. Such a widget may allow for the provision of certain enhanced media, in the form of secondary content to the primary content related to the subject of interest, as is understood to those skilled in the pertinent arts. The enhanced media may include advertising for association with the primary content, that is, for associations with the subject of interest. The widget content may thus be located responsive to query engine 10, may be content obtained from the vault by recommendation engine, and the widget may be formulated via fulfillment engine 14.

In accordance with the recommendation engine, a recommended image enhancement widget may provide website providers and publishers with contextually relevant content for items featured in, for example, editorial images. The widget, such as upon discovering an enhanceable image, may use the enhanceable image as a background to deliver the contextually related content without impacting the layout or other content of the subject website. Further, the ability to deliver the widget in the instant invention may provide a network of, for example, advertising inventory. As such, the image enhancement widget may be recommended by the recommendation engine, and/or may include, or be linked to, content in the vault.

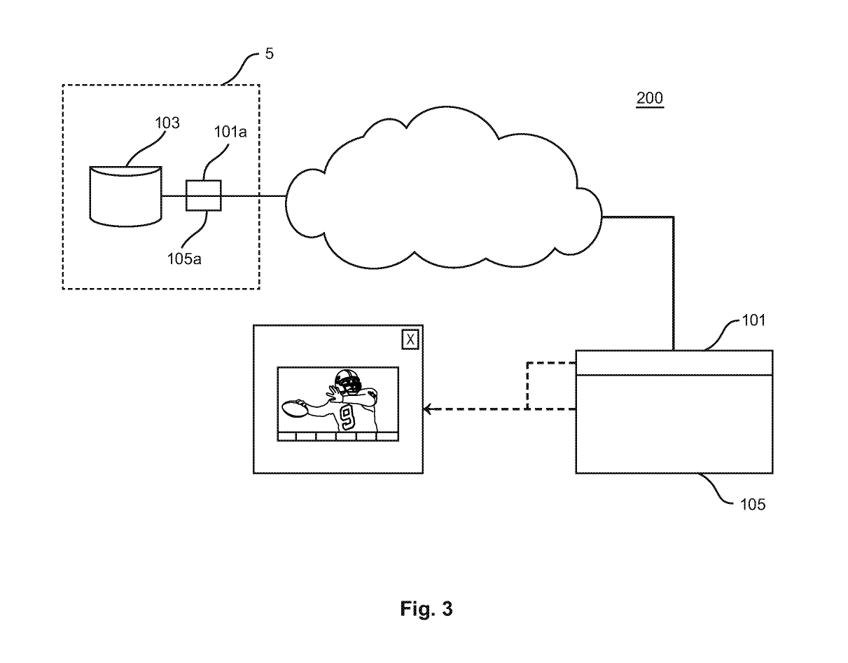

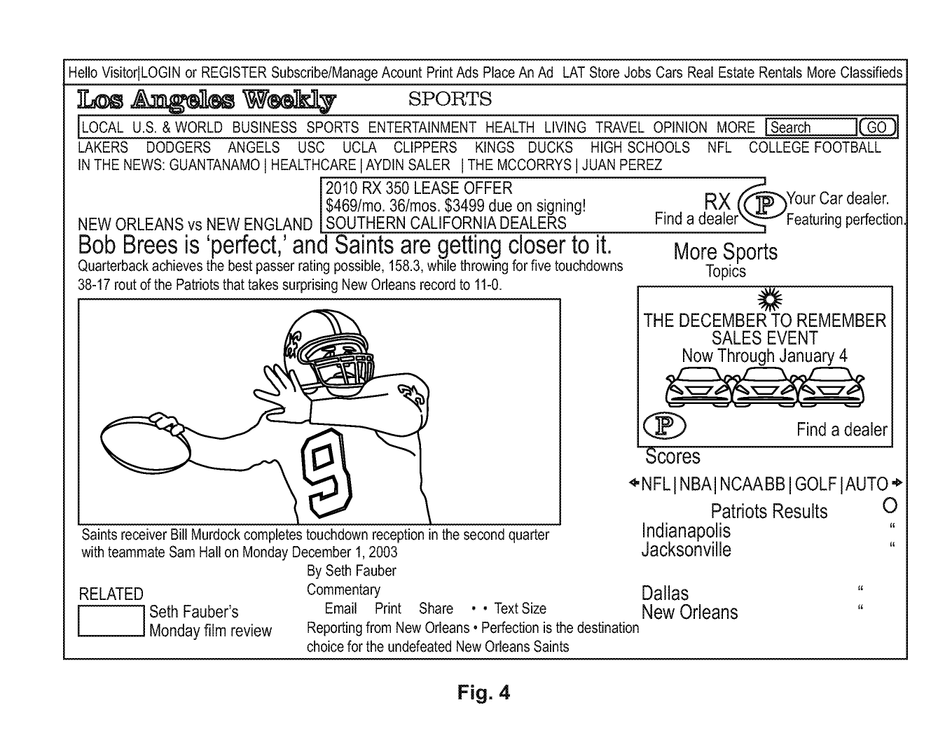

More specifically, and as illustrated in FIG. 3, the image enhancement widget system 200 may include three principle components. These components are a javascript component 101, content 103 from the vault associated with the recommendation engine, such as content obtained by or from the talent server inclusive of the recommendation engine, for association with and/or relation to a talent, and a flash widget 105. Each of the javascript 101 and content 103 may be provided by the recommendation engine discussed hereinabove, and most preferably via the talent server within and/or associated with the recommendation engine. The flash widget 105 may preferably be provided by the fulfillment engine, according to instructions and content received from the recommendation engine.

The javascript component 101 may, for example, be a publisher-side javascript. The publisher side javascript may locate enhanceable images on the publisher's webpage, and provide set up for the flash overlay widget 105 atop the enhanceable image. Provision of the enhancement 105 may be enabled by placement of, for example, a single line of publisher-side javascript onto the publisher website that the publisher wishes to have enhanced. The publisher-side javascript 101 may be added to a website by the publisher in, for example, a one-time set up. Following installation, the publisher-side javascript may be further configured remotely as discussed hereinthroughout, by either the publisher or the enhancement provider, for example.

In an exemplary embodiment, the javascript component 101 may identify images on a webpage, including enhanceable images, and including images subject to required criteria for enhancement, such as size ranges, aspect ratios, or the like. Upon identification of an image, the javascript 101 may capture caption text related to the image, alternate text, and/or an image URL, for example, and may send those elements to the talent server and/or recommendation engine, as illustrated. Further, the javascript may display an alert to show a user that a particular image is interactively enhanceable, such as when instructed to display an alert by talent server and/or recommendation engine. Further, the javascript component may enable set up of the flash overlay widget 105, such as by specifying size, location, publisher, talent identification, menu inclusions, and the like, when a user clicks on or mouses over an enhanceable image. Finally, the javascript component may dismiss the flash enhancement based on an appropriate user action.

In a preferred embodiment, the javascript component may not impact an existing page layout. Neither may the flash enhancement, as discussed further hereinbelow, affect the page layout. The javascript component may include an awareness of sight specific design elements, and browser limitations, for example, such that, if unknown elements or unsupported browser aspects are encountered, the javascript component may dis-enable itself. Further, it is preferred that the javascript not appreciably impact load times for the publisher's site. As such, the javascript component may begin activities only after all native website operations have ended for the particular website.

The javascript component may additionally be self updating. As such, the javascript component may change or improve over a period of time. In a preferred embodiment, the website publisher may not be responsible for maintaining the javascript component after installation, but rather the javascript component may check for available downloads of updates at a predetermined time frame, such as daily, for example, and such as from the recommendation engine, for example. Yet further, the javascript component may preferably be bandwidth neutral with respect to additional traffic over a particular bandwidth.

Thus, the javascript component may be authorized by a particular publisher to enhance any page, or item on a page, that meets certain criteria, such as a size limit, for example, that will allow for enhancement of the item on the page without obscuring the original item or items on the page. If the criteria are met, the javascript component may be installed, and may awaken upon each instantiation of the page, asking for any updates to the javascript component, such as from remote locations, such as the talent server. If no updated versions of the javascript component are available, or after an update is downloaded, the javascript component may assess the images or items on the particular publisher's page, such as by comparison with the criteria, in order to assess which of the images or items may be enhanced. Upon the assessment of which images or items are authorized for enhancement, the javascript component may optionally download the images or items, or certain of the images or items, as a background for the enhancement. The javascript component may then read a text string, such as from an xv header, and may send the information read to a remote location, such as the talent server. The xv header may include, for example, a pix size, an image source, and/or associated textual information, for example. The javascript component may, either prior to sending the information to the talent server, or as information is sent to the talent server, provide to the talent server information related to the reading of the text string, and/or to the assessment of the application of the criteria for the enhancement, for example.

As used herein, the talent server may be or include, individually or in the aggregate, the vault discussed herein and the recommendation engine, wherein the recommendation engine may also serve to authorize enhancements in accordance with certain criteria. The talent server may communicate with the publisher's side javascript component and the flash enhancement widget. When communicating with the publisher's side javascript component, the talent server may manage all communications to and from the javascript component, download images and/or read header files for image or item information, recognize particular talent or entities using header files and all image descriptive texts, indicate to a talent server side javascript the names of talents, certain identifications, such as of image locations, and other required information for the calling of the flash enhancement, download site specific enhancements, and/or provide cache and similar storage, among other functions. The talent server may store, such as in the vault, for example, the myriad of information that may be made available through the flash enhancement, images and information regarding a variety of talent, and the like, for example.

The flash enhancement widget may be a dynamically sized micro site that may use a host image as background in order to provide additional information, preferably related to the subject of the host image, for example. The flash widget may be configured as an overlay, a cascade out of an image into a fixed size and/or relative position, a dropdown menu or series of dropdown menus, and/or an expandable menu or series of expandable menus, or the like. The flash widget provides additional, contextually relevant content regarding the talent featured in an editorial image or item. Through the provision of this contextually relevant content, users may spend additional time on a particular publisher's page. Further, a contextually relevant advertising opportunity may be provided.

The micro site nature of the flash widget may enable various and diverse functionality. This functionality may be dynamically sized and/or modified, such as to fit dimensions, aspect ratios, page location, and the like, of a particular image, and/or to fit similar criteria set forth by the publisher. Likewise, in order to avoid interference with the surrounding webpage, the flash component may have opaque, translucent, and/or transparent components, may continue to display the underlying image, may display the names of the talent discovered in the image, and may have a close, or “X,” button, in order to dismiss the flash widget and return to the original view of the underlying image.

In an exemplary embodiment, and in order to fit a dynamic sizing of an editorial image, a widget may be available from the talent server in multiple modes, such as small, medium and large. Upon loading, the flash widget may select the particular mode, and may self-size to the exact dimensions of the underlying image, or of the expanded image, as desired. By way of example, a small mode may be 300×250 pixels, a medium mode may be 400×300 pixels, and a large mode may be 600×400 pixels, wherein the mode selected is that mode which best approximates the size of the underlying picture.

Further, it is often the case that an editorial image may include more than one talent, or a caption associated with an editorial image may refer to more than one talent. Thus, the flash widget may provide, for example, interactivity, such as a dropdown interface, to allow a user to select what talent to browse in the particular image. Thus, the flash widget may provide a micro site for each subject talent in a particular editorial image including multiple talents. Needless to say, the talent placed at the top of such a dropdown interface may vary based on which talent is being most frequently selected by users with respect to the particular associated editorial image, for example.

The assessment of the subject or subjects of an editorial image may be made, as referenced above, by the javascript component, and may also be made or partially made by the talent server that provides the flash widget. For example, as discussed above, the flash widget may be provided in accordance with information in a header, but, in the event insufficient information is provided in the header, a publisher may provide alt-text, that is, publisher captions, to provide the necessary information, or the javascript can estimate on behalf of the flash widget, such as by reading the entire page and assuming that which is closest to the editorial image is a caption, and the closest caption presumptively includes information on the editorial image.

It almost goes without saying that the present invention overcomes significant bandwidth limitations. For example, it is desirable that the javascript component may do a significant amount of processing, or that the processing may be allotted to the talent server, or that the javascript may be updated on a less frequent basis, for example. Further, by use of the javascript component to read the page header, it is the publisher's site bandwidth, rather than the talent server bandwidth, that will be used in order to assess the enhanceability of all images. Finally, bandwidth may be conserved by allowing the user to first instruct that certain processing occur, rather than doing so automatically. For example, the micro site flash download may only be provided if a user clicks, for example, a button indicating that the editorial image is interactive. Further, in order to provide additional time for download of the flash enhancement and/or to provide additional revenue, advertising or the like may be downloaded and/or shown to a requesting user as the interactivity is downloaded.

Thus, the present invention may allow for the ready installation of the javascript component, such as on a site HTML template. Related information and/or related articles referencing a selected image, or multiple such methodologies, may be selected, such as the selection of RSS feeds. The settings for an enhancement may be selected, such as the criteria and/or content of such enhancements. Further, a publisher may select the look and feel of a particular flash overlay widget, for example.

For example, a publisher may select, as to look and feel of an overlay widget, colors, textures, images, button layouts, sizes, shapes, and the like. Further, certain components may be selected as only conditionally shown to users when certain conditions are met. Further, publishers may select the criteria for production of the enhancement, such as minimum or maximum image sizes available for enhancement, sites, pages, page sections or site sections available for enhancement, use of a floating widget for particularly small images, or the like. Thereby, a publisher may select a look and feel most likely to sustain interest from users of that particular publisher, which, of course, are the users that publisher will know best. Thereby, the publisher's contributions, in conjunction with the present invention, are likely to increase user exposure to publisher's content.

This exposure may be further enhanced by providing, such as through the flash enhancement widget, links to related stories or images using existing RSS feeds, search and content management capabilities, and the like, which may be provided by the publisher or a third party, and which may be provided from that publisher website, or other websites associated with that publisher, for example. Further, user exposure may be additionally maintained through integration of, for example, third party information, such as third party images, videos, statistics, and the like, including, for example, the metrics discussed hereinabove with respect to FIGS. 1 and 2. Needless to say, increased time on a page view may additionally provide increased revenue for the provider of the page, particularly in light of the fact that the present invention may be provided at no cost to the publisher.

Revenue may increase to the publisher not solely in light of increased user engagement and lack of technology investment, development, or provision costs. Publishers may additionally receive value through access to information regarding subject talent of images used on that publisher's website, such as the aforementioned metrics of that talent received from, for example, the talent server, as assessed across multiple websites. Further, the publisher may receive a revenue share on ecommerce transactions related to, for example, advertising provided in conjunction with the flash enhancement. The provider of the flash enhancement may provide this advertising, such as from the talent server, thereby providing an exclusive advertisement position for enhanced images for the provider of the flash enhancement. Further, the provider of the flash enhancement may receive a share of other ecommerce transactions related to the flash enhancement, and may further receive branding and/or links made available through the flash enhancement.

More particularly, the flash enhancement may be ecommerce enabled. For example, shopping support may be provided from third party on-line shopping providers, which third party providers may be relevant to the subject of the editorial image. For example, an on-line team fan shop may be provided as shopping support through an advertisement placed in a flash enhancement widget related to a talent in an image that plays for the team associated with the team fan shop. Likewise, ticket purchasing advertisements, either by teams or third party providers, such as Stub Hub, may be highly targeted to users who have selected to view a flash enhancement related to a subject talent on the particular team for which tickets are offered. Real and virtual sales, memorabilia, clothing, and the like may be provided in association with the flash enhancement advertising. Of course, sponsorships may also be provided in association with the flash widget, thus providing another opportunity for advertising revenue in association with the flash enhancement.

Thus, in an exemplary embodiment, responsive to the javascript component and information assessed by the talent server, the flash enhancement may provide a myriad of information with respect to the subject of an editorial image, such as a professional athlete, in a format selected by the publisher of the site containing the editorial image. For example, a series of clickable menu buttons may be provided via the flash enhancement, wherein each button includes information related to a professional athlete shown in the editorial image on which the flash enhancement is overlayed. Such a clickable menu may provide information on the professional athlete such as biographic information, background information, statistics, team information, such as box scores and standings, and the like. Further, social information may be provided on the athlete, such as the buzz and/or metrics associated with the athlete, recent postings by or about the athlete, real or virtual memorabilia, and/or advertising or media metrics wherefrom an assessment may be made of the propriety of using the subject player as an endorser for advertising, for example.

The information provided in relation to the player may be highly targeted, such as by making use of related articles or feeds from the publisher of the site under enhancement, or from other sites by that publisher, internal or external related articles, relevant blogs or blog postings by the player or fans of the player, or other images of the player, for example. The social engagement in relation to the athlete may allow for reference to the athlete's social websites available to the public, or chatter about the athlete on social sites, recent blogs or postings about the athlete on social sites, or addition of the athlete, or a widget associated with the athlete, for example, to a user's social site, for example. Likewise, shopping, sweepstakes, trivia, and fantasy sports support and/or integration may be made available with reference to the particular athlete.

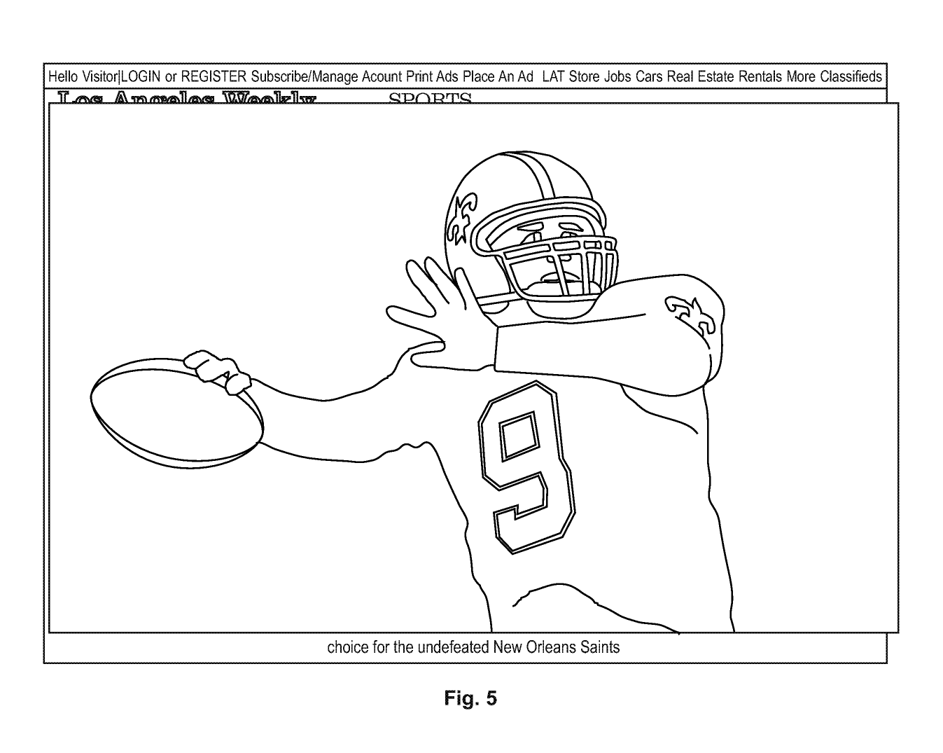

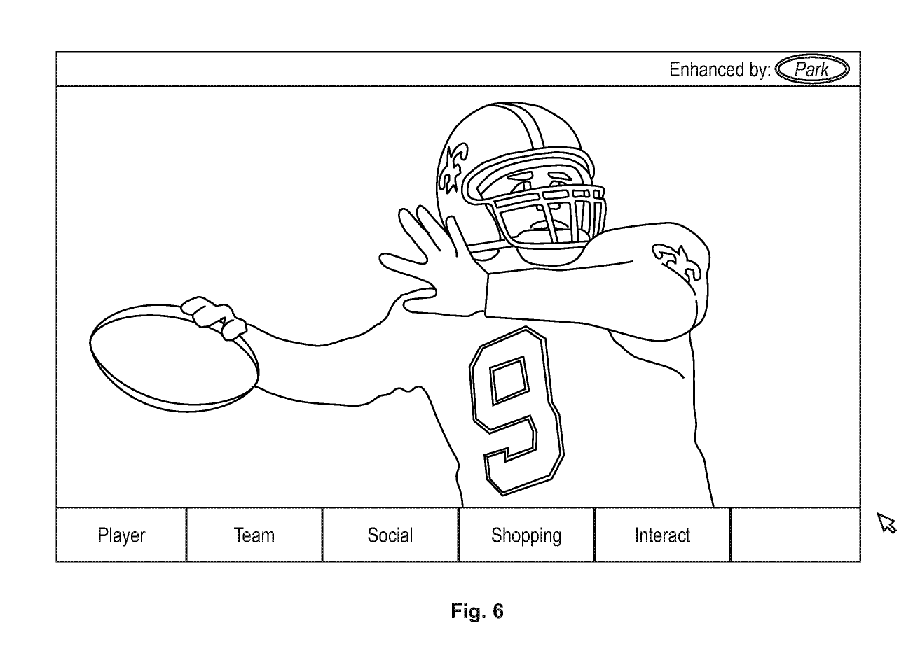

FIGS. 4-13 illustrate an exemplary embodiment of the present invention. FIG. 4 illustrates an editorial image provided in association with a publisher's website. FIG. 5 illustrates that the subject editorial image may be optionally enlarged, such as upon clicking or mouse over, to enable use of the flash enhancement widget of the present invention. FIG. 6 illustrates a flash enhancement overlay placed atop the subject editorial image selected for enhancement. Of note, the overlay illustrates a top level sponsor for the enhanced overlay. Further, the overlay as illustrated includes information regarding the player, the team of the player, social aspects related to the player, shopping related to the player, and interaction with and about the player. Further provided is a branding and/or link to the provider of the flash enhancement.

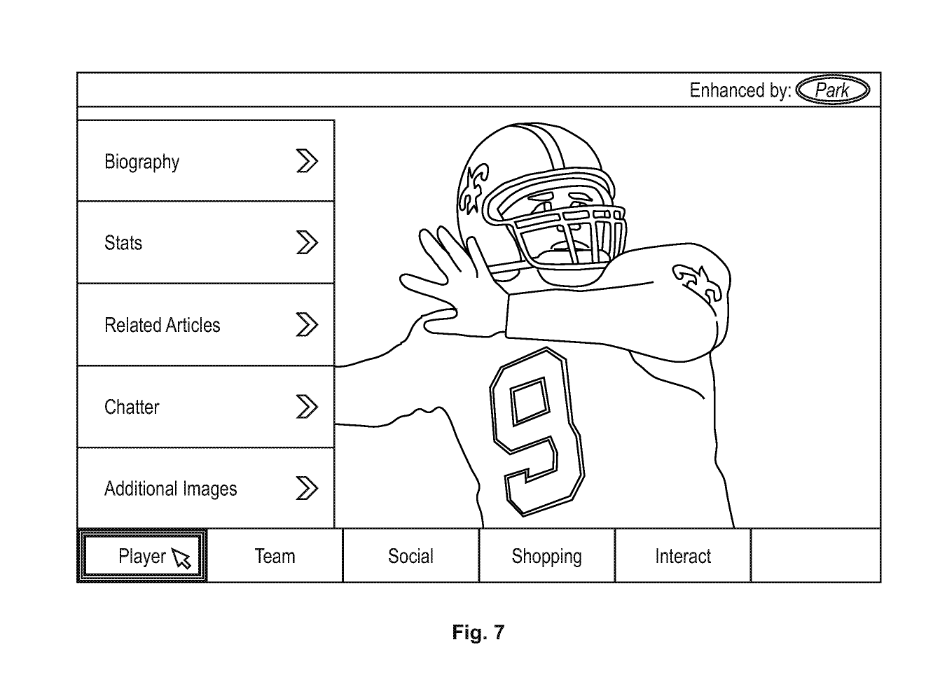

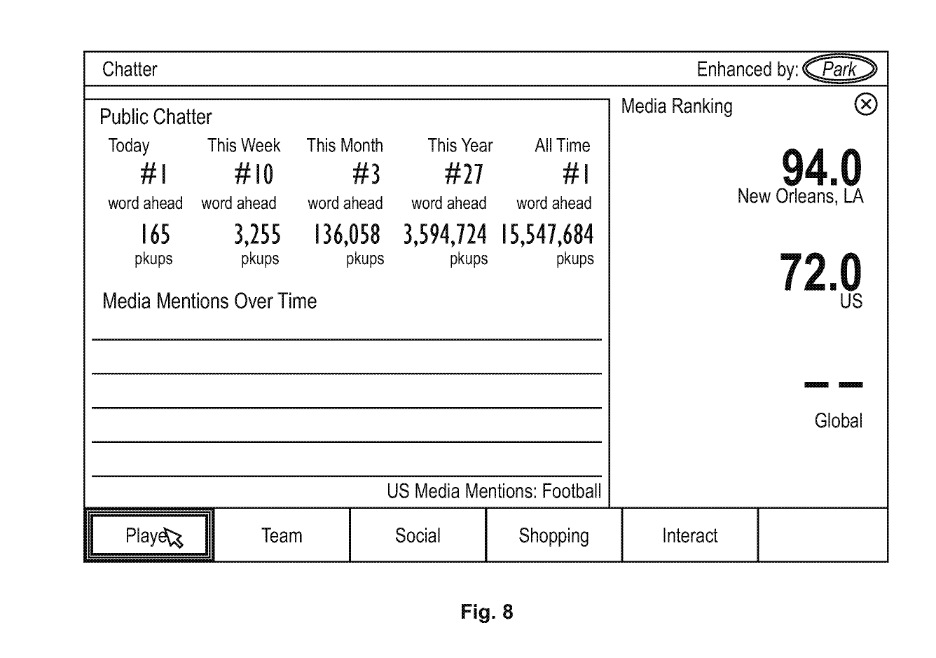

FIG. 7 illustrates a mouse over or similar selection by a user of the player tab of the enhancement overlay. Selection of the tab may allow for presentation of numerous options with regard to the player, such as the biography of the player, statistics of the player, articles related to the player, chatter about the player, and other images, audio, or video related to the player, for example. The statistics of the player may include, for example, game and career statistics for the player, scores or articles about the most recent game in which the player has played, and the like. FIG. 8 illustrates the selection of chatter about the player. As illustrated, chatter may monitor mentions of the user on certain subject sites, or across many websites, and may additionally monitor whether such mentions are positive or negative, i.e. may metricize such mentions as discussed hereinabove with respect to FIGS. 1 and 2.

The player illustrated in FIG. 7 plays for a team in New Orleans, La., and thus, it would not be surprising that the media rating, and/or metrics, of the player would be higher in New Orleans than in the rest of the United States. This is illustrated in FIG. 8. Further, the metrics may track chatter about a subject talent over time, as illustrated. The metrics provided may vary based on the flash enhancement selected to be provided. For example, a small sized flash overlay may provide simply a local and national on-line ranking for a selected talent. However, a medium overlay may additionally include a graph of a national and local ranking of the talent for a particular time period, such as over the proceeding three months. Finally, for large sized overlays, mouse over effects may be provided, such as showing specific ratings at given points on a ratings graph.

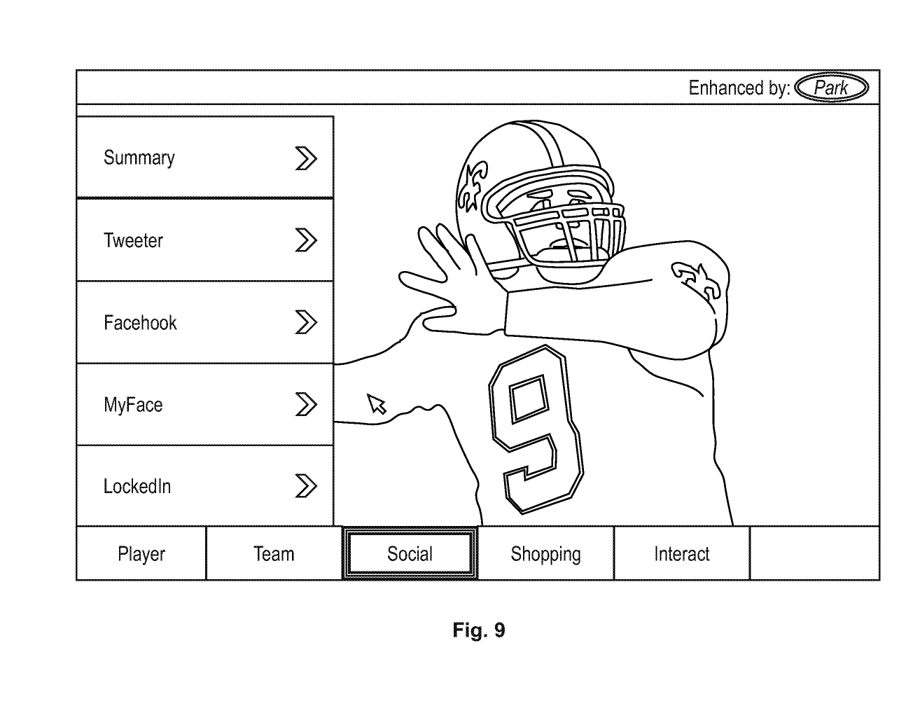

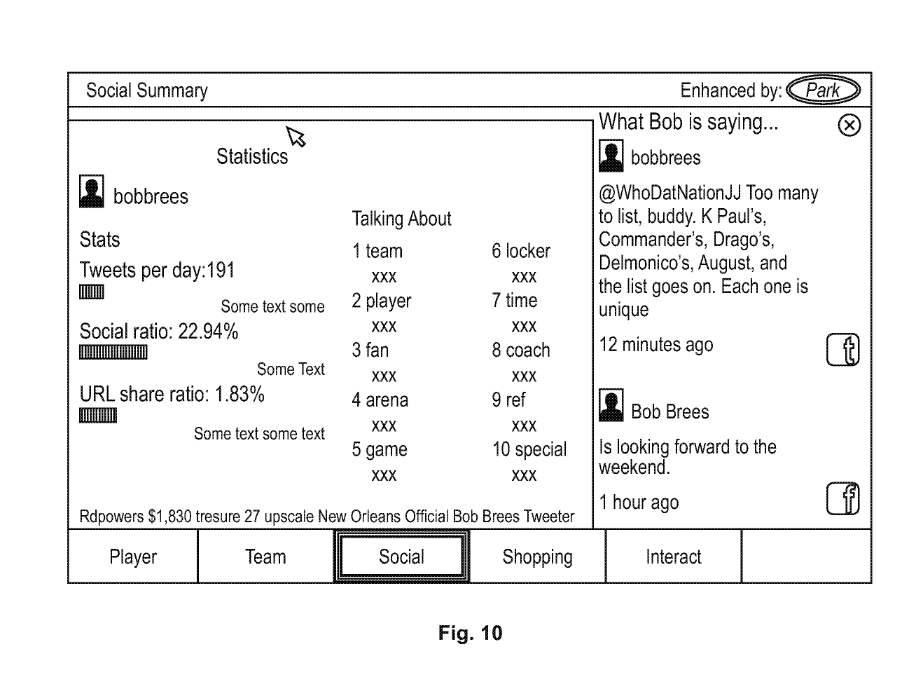

FIG. 9 illustrates a selection, or mouse over, of a social tab in the flash enhancement. Selection of the social tab may provide, for example, a series of aspects related to socializations of the player. For example, social network sites provided by or for the player may be accessible, as may be mentions associated with particular social networks about the player. Further, for example, recent posts on a social site about a talent featured in the editorial image may be provided, such as an association with a logo or link regarding the subject social network site. Additionally and alternatively, a summary of that talent on a social network site, such as a profile icon and/or summary of a profile of the subject talent, may be provided from the social network site. FIG. 10 illustrates an exemplary social summary with regard to the subject of the editorial image. As illustrated, social interactions of the talent may be tracked, and additionally statistics regarding mentions of the talent and the like may be provided.

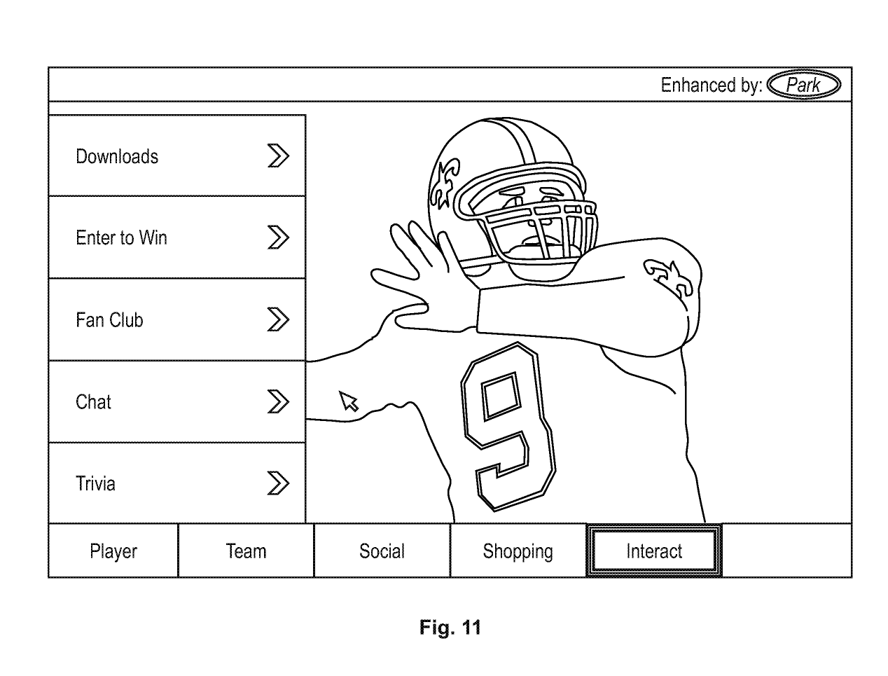

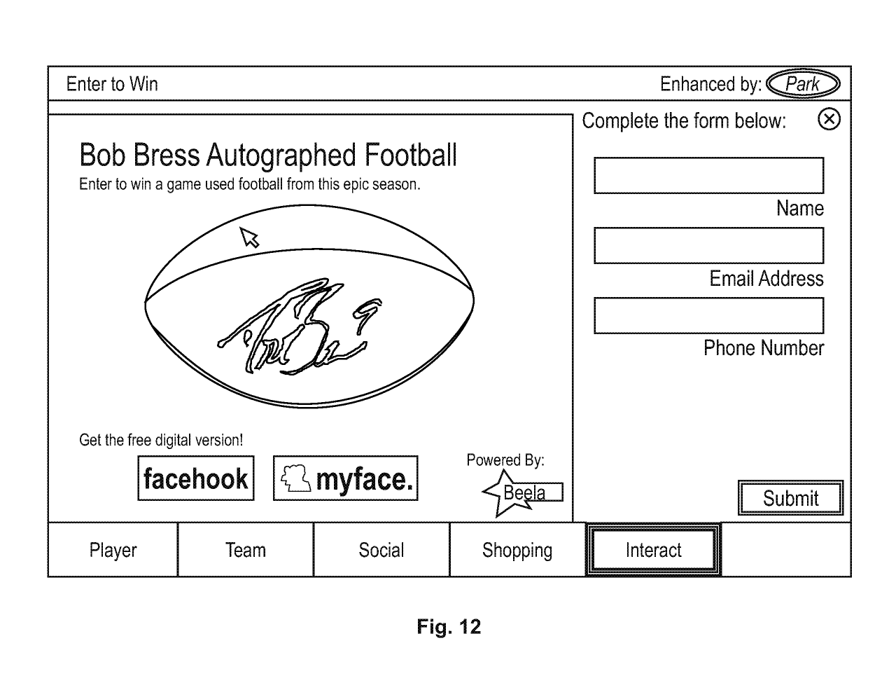

FIG. 11 illustrates a selection and/or mouse over by a user of the interaction tab of the flash enhancement. The interaction tab may provide a plurality of interactions related to the subject talent of the editorial image, such as downloads related to the talent, sweepstakes related to the talent, fan clubs of the talent, chat with or about the talent, trivia related to the talent or an entity associated with the talent, or the like. For example, as illustrated in FIG. 12, a user may elect to enter a contest or sweepstakes associated with the subject talent. Further, as illustrated in FIG. 12 and as referenced hereinabove with each aspect of the flash enhancement overlay, portions of the flash enhancement provided may be transparent or translucent, such as in order to allow continuous presence as background of the original editorial image.

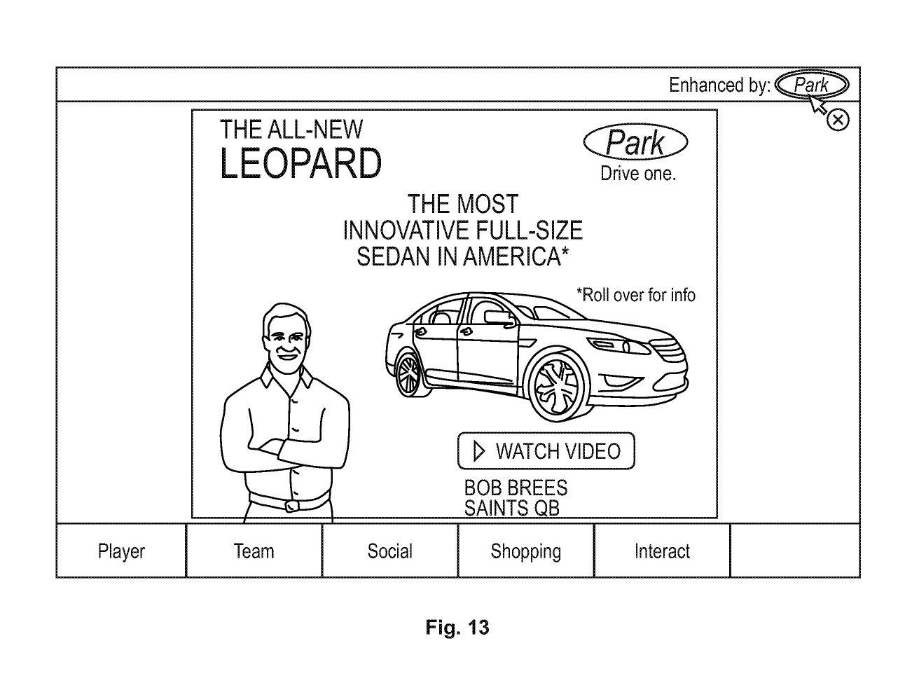

As illustrated in FIG. 13, a sponsor may be provided for the flash enhancement. The sponsor may be selectable by a user, at which time an advertisement associated with the sponsor, and/or featuring the subject talent of the advertisement, may be provided to the user. Additionally and alternatively, a banner ad may be provided within, or associated with, the flash enhancement widget. In a preferred embodiment and in order to avoid conflicting advertisements, it may be necessary that, when an advertisement or banner advertisement is displayed in accordance with the flash enhancement widget, underlying advertisements and/or images may, contrary to that discussed above, not be visible to the user.

In an exemplary flow of the present invention, when a user on a web page places a cursor over a subject of interest in a particular article, the mention may be formatted as an enhanced flash media widget, such as wherein the mouse-over causes execution of widgetized code to provide a widget specifically designed for association with a reference to the subject of interest. Such a widget may provide additional information regarding the subject of interest, advertising endorsed by or otherwise associated with the subject of interest, desirable and/or free content, content from and/or stored in the vault discussed hereinabove, or any combination thereof, for example. Thereby, revenue gained through the provision of the subject widget, such as from click-throughs on advertising provided in association with the widget, may be shared between the provider of the widget and the site provider that allowed placement of the enhanced media, for example.

More specifically, the enhanced media may link to a particular item, and/or may provide access to different optional items, such as by provision of tabs in association with the widget provided correspondent to the mouse over. Advertising and other enhanced content may be provided from inventory in the vault. Thereby, revenue sharing between one or more of the advertising entity, the subject of interest, and the site provider may be made available through the use of the present invention.

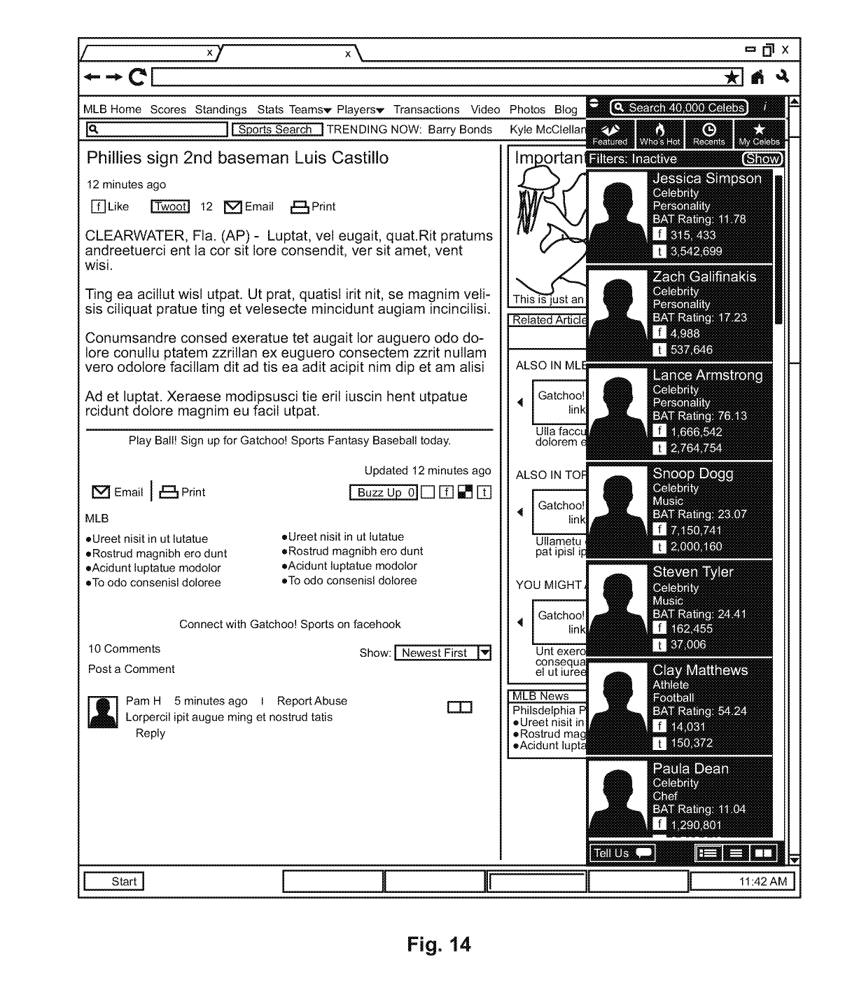

In an embodiment of the present invention, the enhancement widget may be presented as a discreet window provided to the user and may take the form of an overlay, a free-standing window, and/or a window within an active window, for example. As illustrated in FIG. 14, the widget may take the form of a sidebar which may exist within an active window being utilized by the user to surf content on the internet. The sidebar may offer a specific subset of information to the user and may be tailored and/or customized pursuant to user characteristics and/or the content within the main window utilized by the user. For example, such specific content may include information regarding celebrities.

Celebrities as used herein may be people, objects, and/or events which are known to more than one person. In regards to a social network, a celebrity may be any person or persons with a social network following of at least 10,000 people, for example. Outside a definable electronic following, a celebrity may a person who is known for at least one particular reason by a high number of people. For example, a person known by 20% of adults in the United States may have “national” celebrity, while the quarterback for a local high school team, known by at least a majority of those attending the high school might be a “local” celebrity.

A celebrity may also be defined by their brand affinity rating, a rating which may be calculated in accordance with U.S. patent application Ser. No. 12/322,940, entitled System And Method Of Assessing Qualitative And Quanatative Use Of A Brand, filed Feb. 9, 2009, the disclosure of which is incorporated by reference herein as is set forth in its entirety. Further still, celebrities may be identified and/or sorted by the number of followers the person and/or object has in various social networks. For example, a person may have a twitter following of over 100,000 followers and may qualify themselves as a “celebrity” in relations to the total followers of other twitter users. 1

The sidebar of the present invention may be made visually active by the user and may provide thumbnail information related to the specific information being provided. For example, celebrity information may include a thumbnail picture of the celebrity, the celebrity's name, the celebrity's rating and the celebrity's current occupation such as, actor, athlete, chef and/or writer, for example. The thumbnails may be arranged in a vertical format within the sidebar and may be accessed by scrolling down within the sidebar utilizing the included scroll bar functionality associated with the sidebar. As will be appreciated by those skilled on the art, the views provided by the sidebar may be varied pursuant to the users tastes and may not include, for example, images within the thumbnails to conserve bandwidth and/or processing speed of the devise on which the sidebar is being utilized.

Although the enhancement aspects of the present invention may run against one or more active windows without at least visual activation by the user, the sidebar may be presented and/or activated by the user on one or more of the users' active windows. Such functionality may be controlled by the user and may allow the user to visually access the sidebar only when activated within each discreet window, or may allow the user to choose to allow the sidebar to be active in each and every window the user activates. The user may also allow the sidebar to be active only within certain windows which may deal with, for example, information related to the information within the sidebar. By way of example, a sidebar providing information on celebrities may be limited by the user to be active only against URLs and/or actual delivered content related to celebrity information. Thus, active windows pertaining to strictly business functionality may not be availed access to the sidebar and/or may disable it completely.

As illustrated in FIG. 14, the sidebar may include a search function wherein a user may enter a celebrity's name and/or occupation for example and be returned a list of results to select from. Such results may, for example, be optimized and/or filtered versus the user's attributes, the popularity of certain celebrities by other third party users of the sidebar, and/or the ratings previously described above. The sidebar may also include options to view featured content such as that content chosen by a third party sidebar administrator, an option for the user to review recent celebrity selections, view what may be considered “hot” by other users of the sidebar, and/or a search or simply list celebrities denoted by the user as their favorite celebrities. These favorite celebrities may be celebrities for which the user wishes to track by deliberately selecting them for inclusion within the normalized view of the sidebar, and/or may be celebrities chosen by the present invention to be included in the users normalized sidebar view when taking into account user attributes.

In addition to being provided a separate tab showing what celebrities may be most actively viewed by other users of the sidebar, simply mousing over the thumbnails of the provided celebrities may provide information related to third party viewing of that celebrity. Such information may include, for example, the number of third party users who have not celebrity included within their sidebar and/or the number of users who have searched and/or viewed information related to that celebrity. Similarly, mousing over a celebrity thumbnail may provide the user with third party information related to that celebrity such as, for example, articles, news, and/or social website activity either about or interacted with by the celebrity. Such information may also be included in a separately generated window if the user for example selects a particular celebrity from within the sidebar.

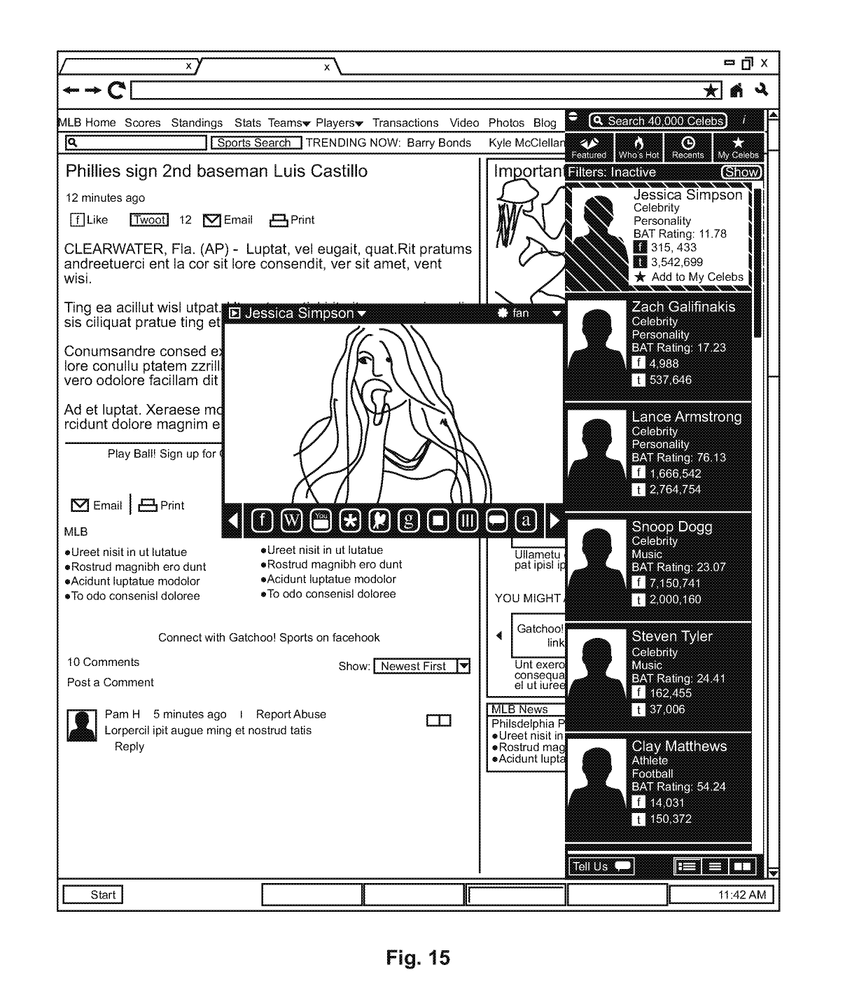

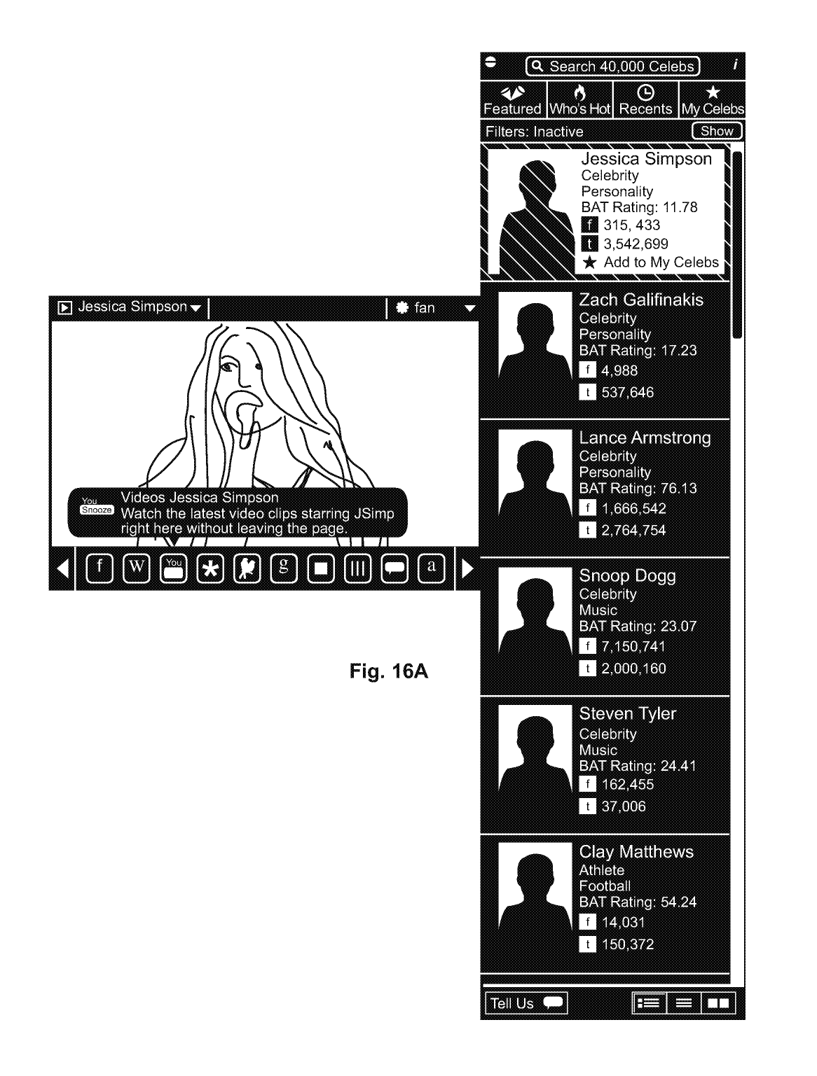

As illustrated in FIG. 15, a window generated by the user selection of a particular celebrity may provide the user with greater information and access to the particular celebrity. For example, more information may be provided in the immediately executed window which may form a part of the sidebar. The information provided may take the form of an additional image, for example, and may further include drop down menus and/or access to various applications and/or widgets.

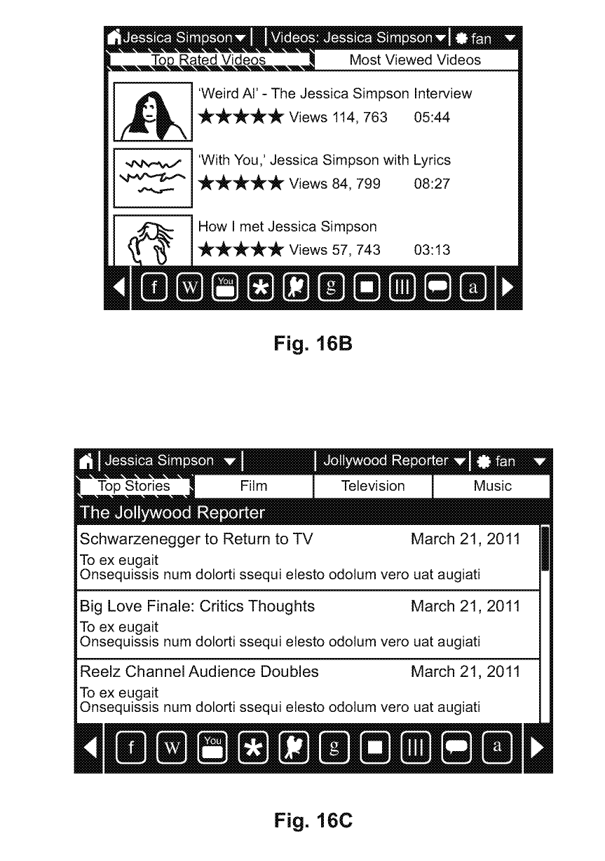

For example, as illustrated in FIG. 16A, access to various applications, social networks, RSS feeds, and the like may be focused on the celebrity presented within the sidebar window. If information related to the selected celebrity exists through one of the aforementioned platforms, such information may be revealed at least in part by the user mousing over the platform's icon. By way of further example, mousing over an icon representing access to You Tube may provide at least an indication of and/or information related to content available through You Tube related to Jessica Simpson. If a user selects one of the platforms provided by the secondary sidebar window, that information may be provided within and contained by the secondary window, as illustrated in FIG. 16B. Thus a user choosing the You Tube icon may be presented with videos within the You Tube interface that are relevant to Jessica Simpson. These videos may be played and/or reviewed from within the secondary window and thus not disturbing and/or interacting with the content delivered to the user within the main window.

Similarly, a selected platform's functionalities may be condensed and presented within the secondary window such as illustrated in FIG. 16C, where the Hollywood reporter magazine has been selected by the user while within the secondary window dedicated to information regarding the celebrity Jessica Simpson. Although the present invention may return celebrity specific information in a hierarchical manner, information, or at least recent information, may not be provided or available at each platform provided through the secondary window of the sidebar.

As illustrated in FIG. 16C, the selected platform of the Hollywood reporter may provide to the user within the secondary window tabs delimitating top stories, film topics, television topics and music topics. If the content and/or information provided by the Hollywood reporter within its top stories tab does not pertain at least directly to Jessica Simpson, the results presented to user even within the Jessica Simpson denoted or directed secondary window may simply include those articles provided by the Hollywood reporter within its top stories tab to viewers of such content directly through the Hollywood reporters main website. Thus to be clear, any platform may be offered within the sidebar and/or the sidebar secondary window regardless of the relevance that the accessed application may have to the celebrity that may be associated with the user.

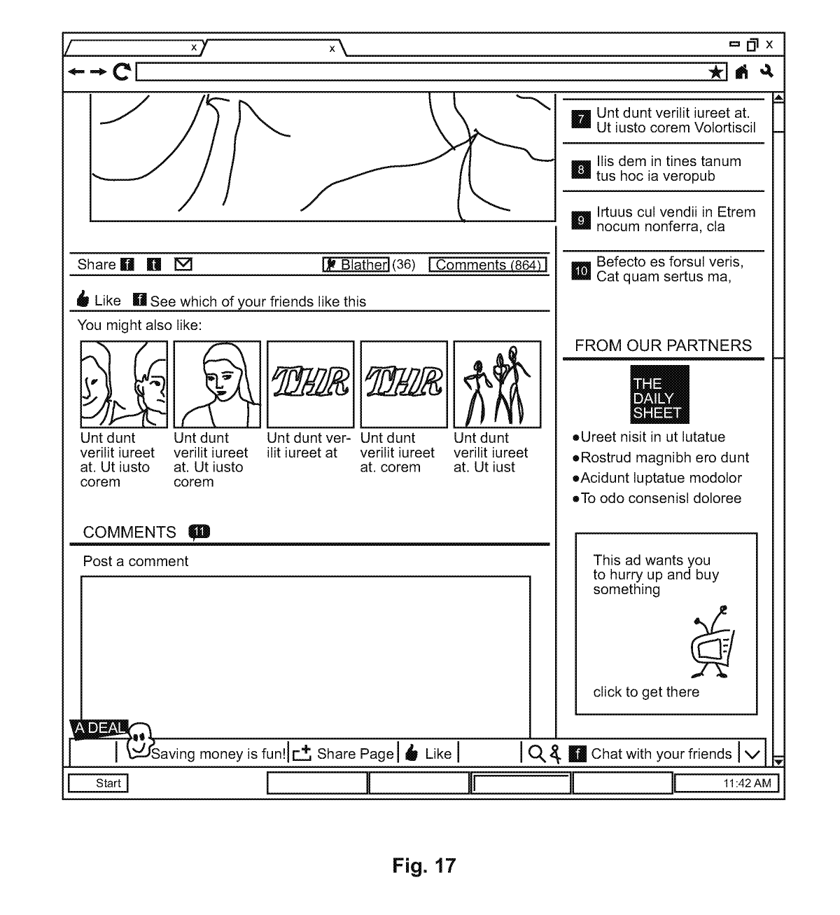

Although as previously discussed the content launched by the user through the secondary window may be limited to functionality within the secondary window, the present invention may also allow for the launching of a new window in which the selected content may be viewed by the user. As illustrated in FIG. 17, launching content in a new window may allow the user to interact with such content as if the content was accessed directly without launching through the sidebar. However, the present invention may review the sites contents and may provide the user the opportunity to further access enhancements related to the information within the user's sidebar. For example, if the sidebar provides the user with celebrity information, the present invention may review the content of the website for it mentions of celebrities and may further look for images connected to the mentions of the celebrities, for example. If, for example, images are found and are determined to be related to at least celebrity mentions, the present invention may tag the images with a small overlay icon denoting that enhancement by the sidebar is available to the user within that web page. As will be discussed in more detail below, such sidebar enhancement may provide the user the ability to add information to the sidebar and/or may provide the user with greater information regarding the at least one identified celebrity.

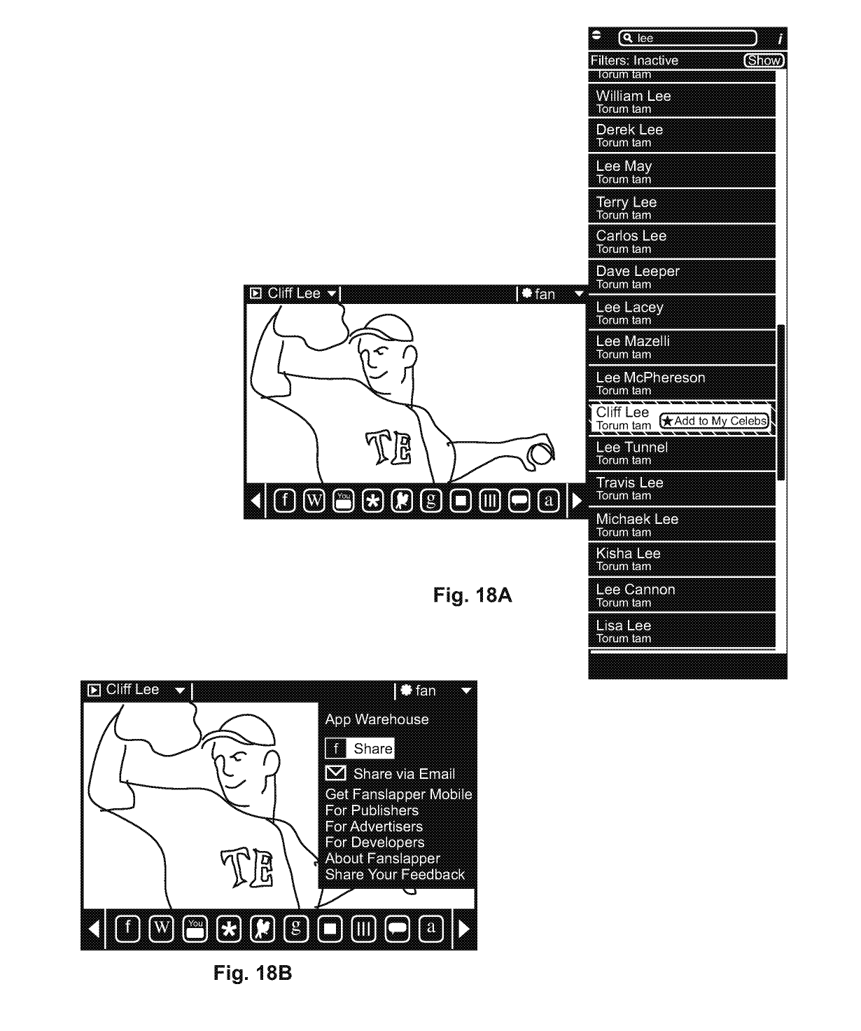

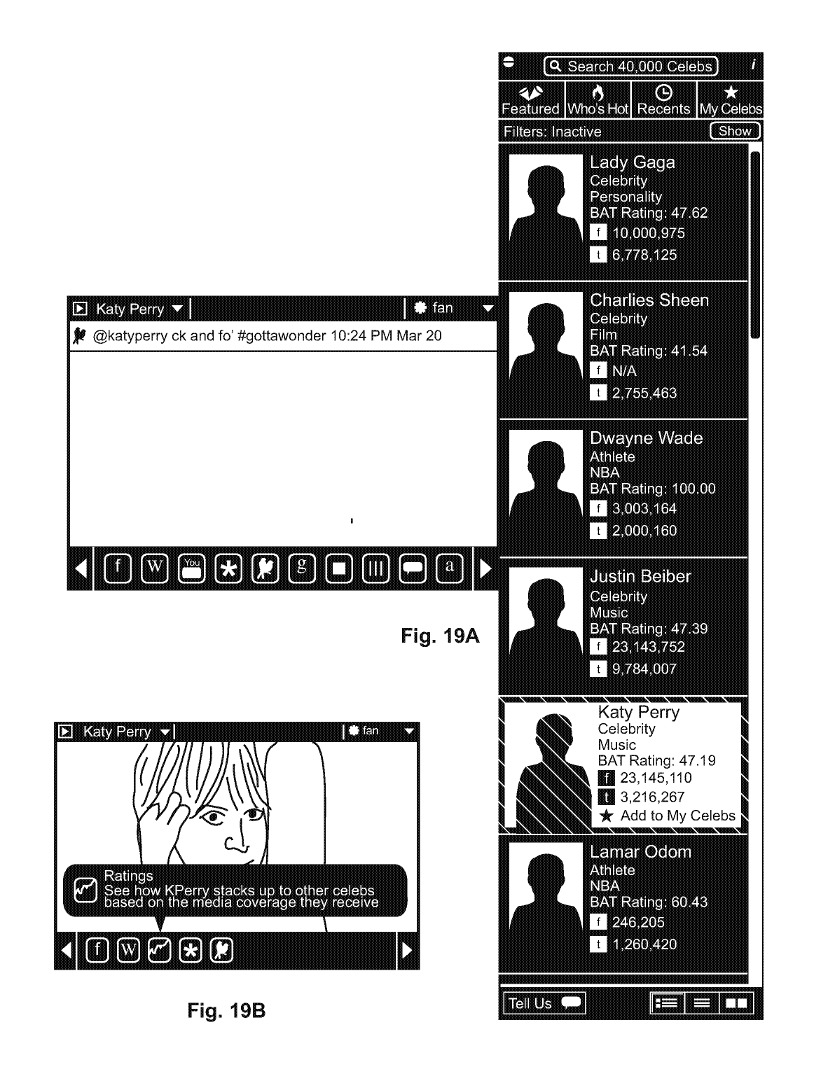

As previously mentioned, a search performed within the sidebar may provide a list of celebrities such as that illustrated in FIG. 18A. For example, a search of the word Lee may result in a listing of celebrities having a first or last name of Lee and/or the letters L-E-E within their name. A selected result may launch the sidebar secondary window providing more information regarding the celebrity and may provide the user the ability to add the selected celebrity to their sidebar list of celebrities for which they desire to track information for. As illustrated in FIG. 18B, the secondary window may be separated from the sidebar and may be provided with a drop down menu which may allow access to various features provided through the present invention. Such features may include access to an application warehouse, allow the user to share via Facebook and/or other social networks, may allow the user to share via email and other forms of electronic communications, and/or provide access to publishers, advertisers and/or developers of applications to, for example, system number 5 of the present invention.

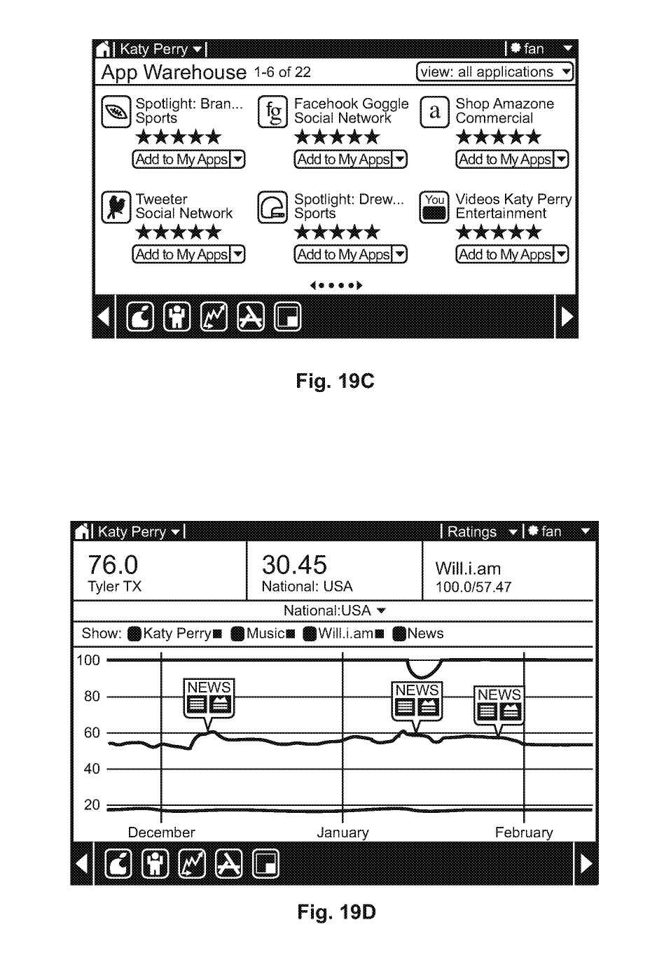

The sidebar may also provide a user with instant access to information related to sidebar content, such as social network postings, for example. As illustrated in FIG. 19A, selecting the celebrity Katie Perry may provide the user with the most recent posting(s) by Katie Perry to a social network. Thus, the present invention may provide a clearinghouse aspect allowing a user to receive any number of social network postings made by a user defined subset of celebrities. This clearinghouse aspect also applies to any and all content available through the worldwide web related to the user defined or specified celebrities. Furthermore, as illustrated in FIGS. 19B, 19C and 19D, the present invention may also provide access to applications, such as, for example, system metrics related to each celebrity through an application icon located either in the sidebar or the secondary window as illustrated.

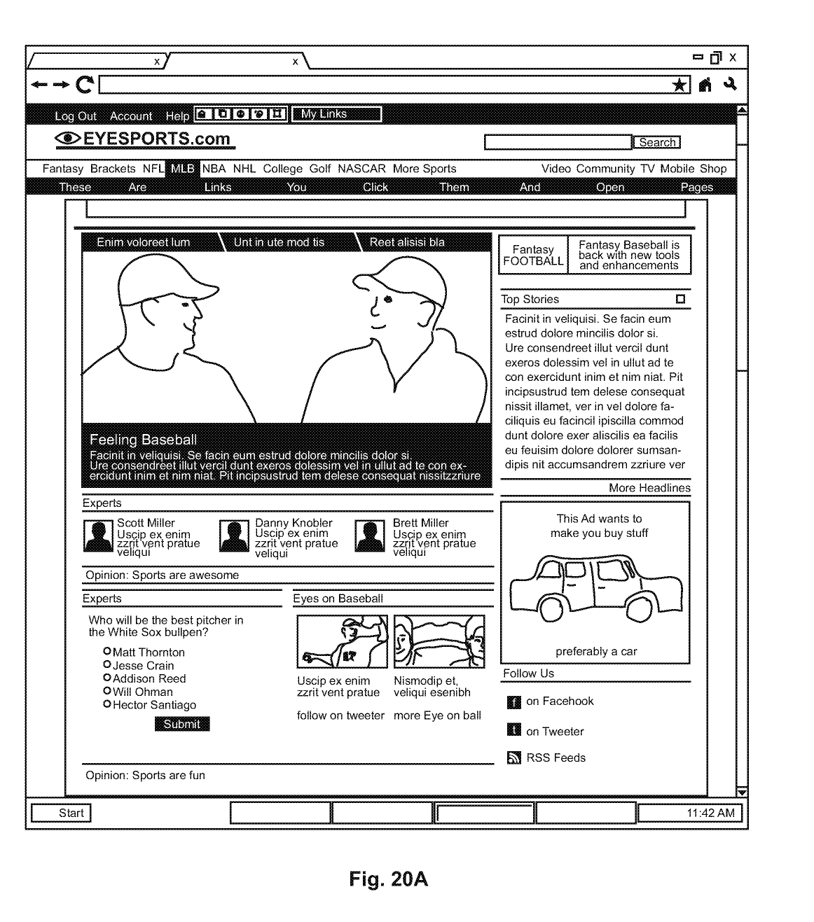

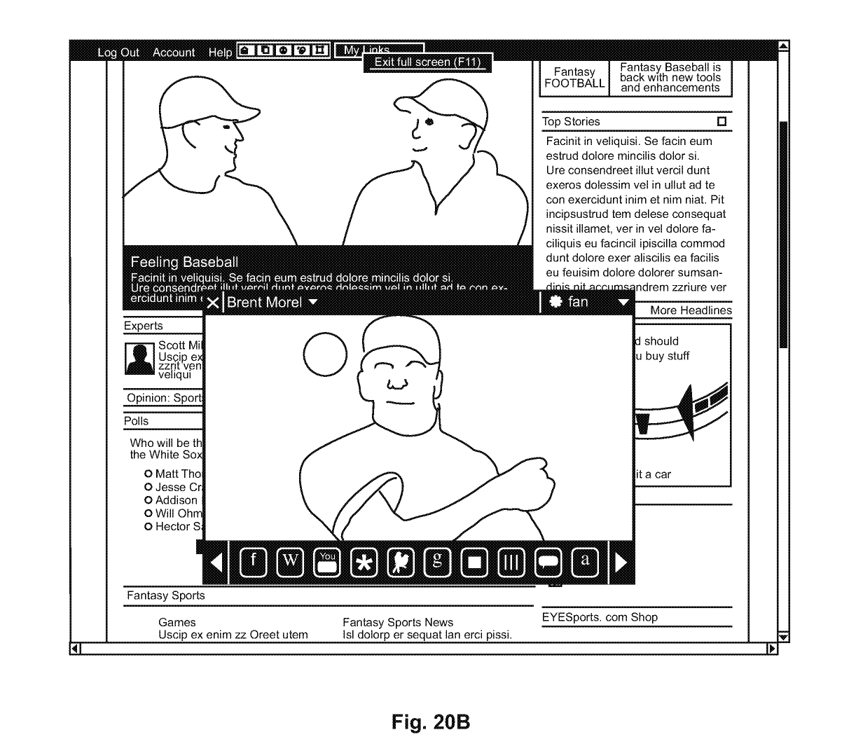

As previously mentioned, the present invention may allow for the enhancement of content located on third party web sites and may provide an indication to the sidebar user that such content is available. As illustrated in FIG. 20A, a small insignia or mark may be provided on content which may be enhanced within the third party web page. The noted content may be selected by the user and may provide an enhancement as illustrated in FIG. 20B. Thus, a secondary window, as described above, may be provided to the user within a primary content window otherwise uncontrolled by the sidebar. In this way, without at least visual activation of the sidebar, content interacted with by the user may still be enhanced as described herein.

Included with, associated with, or discretely from the plug in of the present invention, a top line interactive interface may be provided. The top line interface may allow for real-time interacting with the media enhancements and/or sidebar discussed herein, and/or with the live browsing of a person of interest to the user. As used herein, a top line interface includes at least one indicator button, banner, bar, or the like, visually proximate to the domain listing location in a web browser interface, or the top bar in an application interface. A top line interface, as used herein, stands in contradistinction to a sidebar interface, as also referenced herein. For example, a sidebar interface may serve to aggregate data, such as browsing data wherefrom interests may be discerned, whereas a top line interface may serve to provide an alternative browser or app functionality.

For example, the top line interface provided by a plug in of the present invention may provide a social browsing experience, wherein a third party can, in essence, control the browsing view of a user, not unlike an ActiveX experience as will be understood of skill in the art. For example, a celebrity may have followers, and when the celebrity accesses Twitter, Facebook, or another site, the top line interface may indicate that the celebrity is “live”, wherein live indicates the celebrity is actively using a web-based program. Accessing the top line interface may allow the user to watch and/or participate in the celebrity's “live” browsing experience.

The top line indicator may indicate to the user that a celebrity is broadcasting a browsing experience, and that the user may participate in that browsing experience. Thereby, a celebrity or similar well known personality may broadcast simultaneously to millions of users, including the broadcasting of audio chatting, video chatting, a social browsing experience, a Web surfing experience, or the like, wherein the millions of users may or may not be followers or fans of that well known person.

Thereby, for example, a celebrity may poll viewers and/or followers accessing through the top line interface as to an action of the celebrity, a purchase of the celebrity, a participation of the celebrity, or the like. For example, a well known celebrity may broadcast a shopping experience wherein that celebrity is shopping for dresses, and may poll the followers of that celebrity as to which dress the followers of that celebrity would like that celebrity to wear to the Oscars. Similarly, the celebrity may broadcast an experience through that user's social webpage wherein the celebrity actively does research regarding a role the celebrity has been offered, and wherein the celebrity may poll followers as to whether or not the celebrity should take on the role based on the shared research experience.

Of course, it goes without saying that the social browsing aspects of the present invention are not limited to followers participating in the experience of a celebrity or well known personality. For example, any entity can broadcast a browsing experience through the use of the present invention, and thereby other entities can participate in that browsing experience through the use of the top line interface of the present invention. The exposure of the browsing experience may be, for example, mandatory or optional, such as wherein a teenager's browsing experience is mandatory to allow viewing by parent of the browsing experience in real time. Of course, such viewing in real time of the browsing experience by the parent, or by any external participant, is preferable to occur on a different computing system than the underlying internal browsing experience.

The indication of a “live” session as provided by the top line interface may take various forms. For example, the top line interface may provide a ticker that shows when one or more personalities are live on-line, thereby allowing followers to participate in the desired viewing experience of any personality that the viewer follows. The indication of which personalities the user wishes to follow in the top line indicator may be set from, for example, an indication to, a search within, or the tracking of users preferences by, the sidebar. Likewise, a ticker in the top line interface may indicate what activity, what site, or the like is presently being viewed or undertaken by particular personalities.

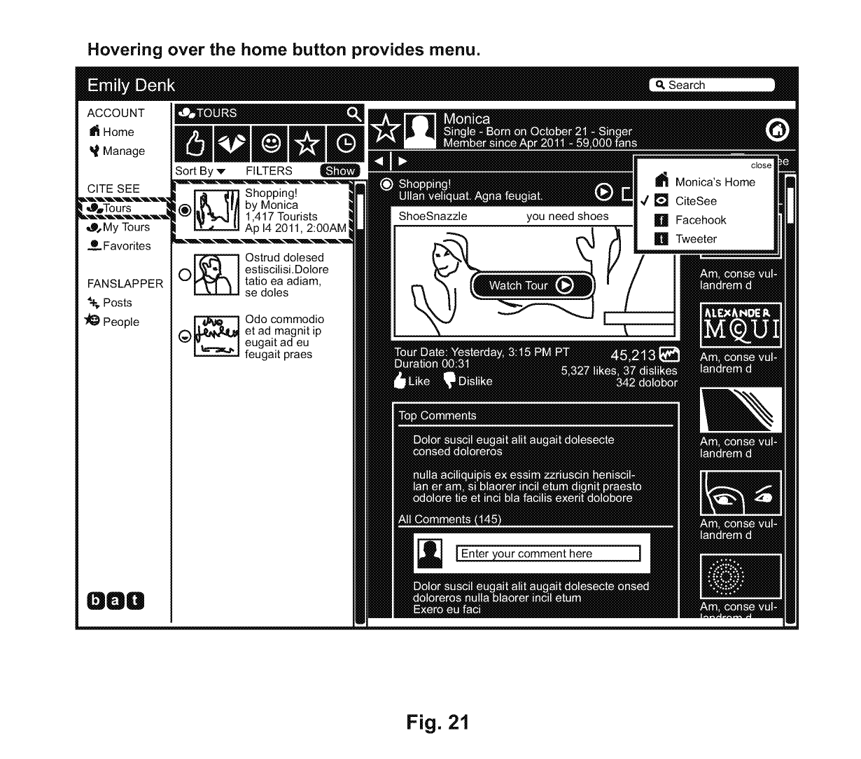

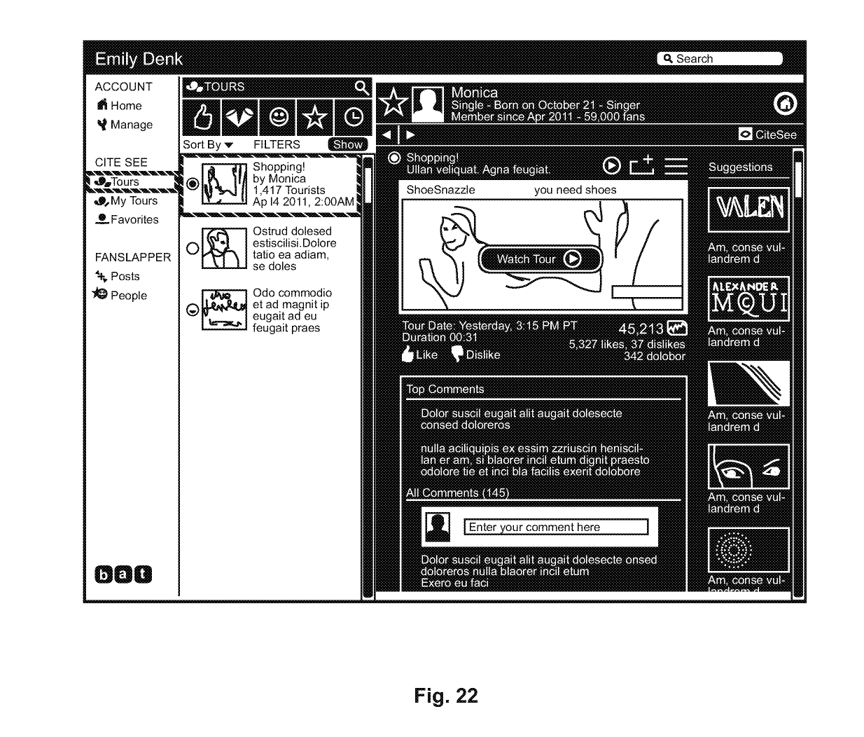

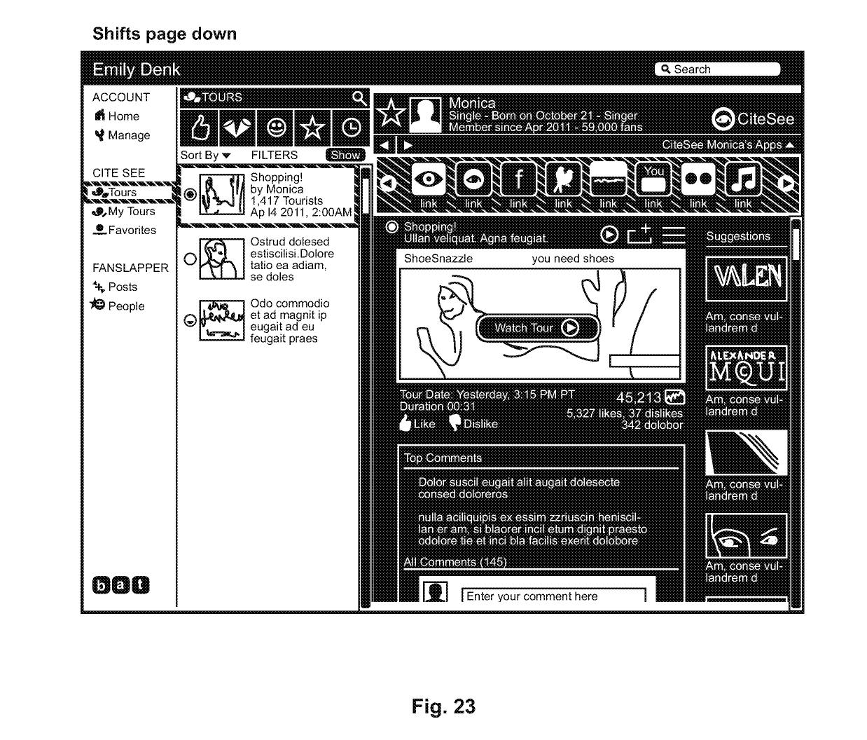

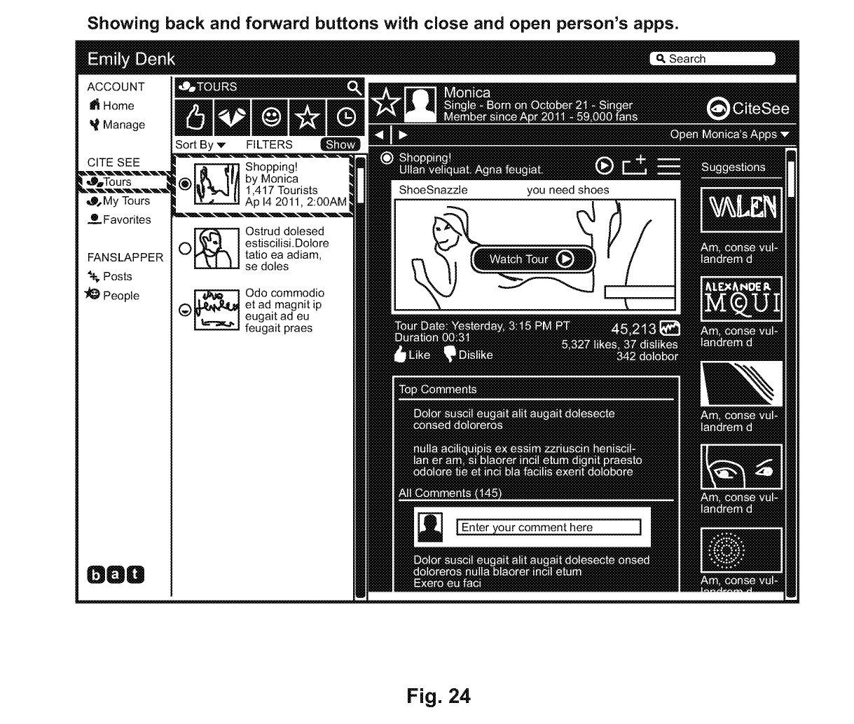

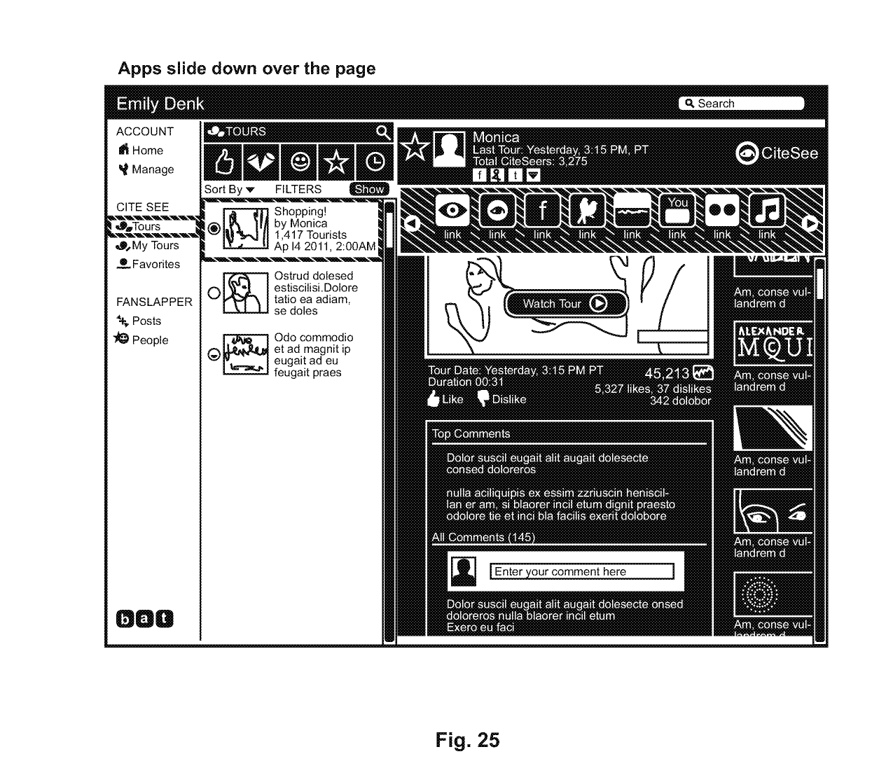

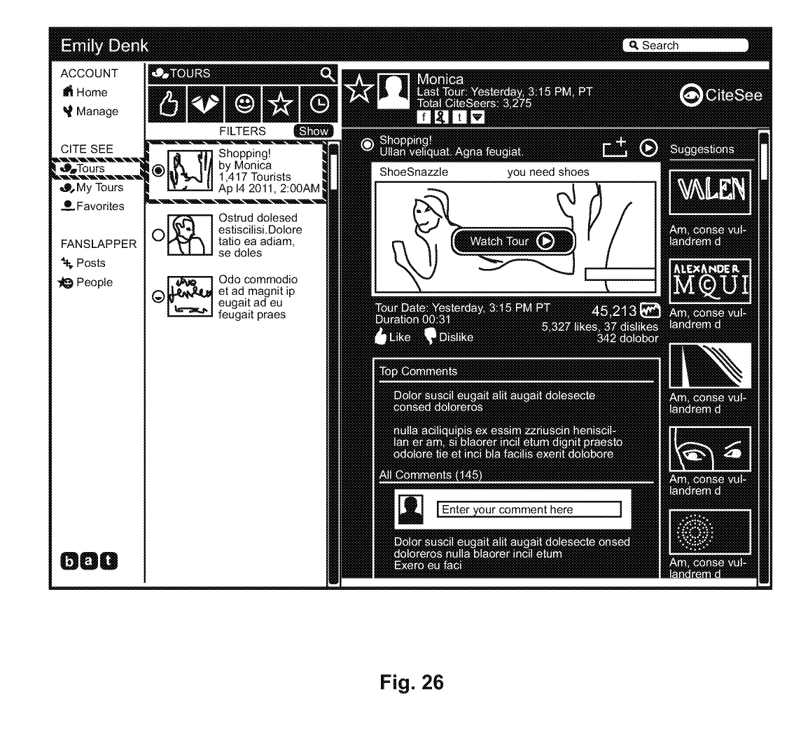

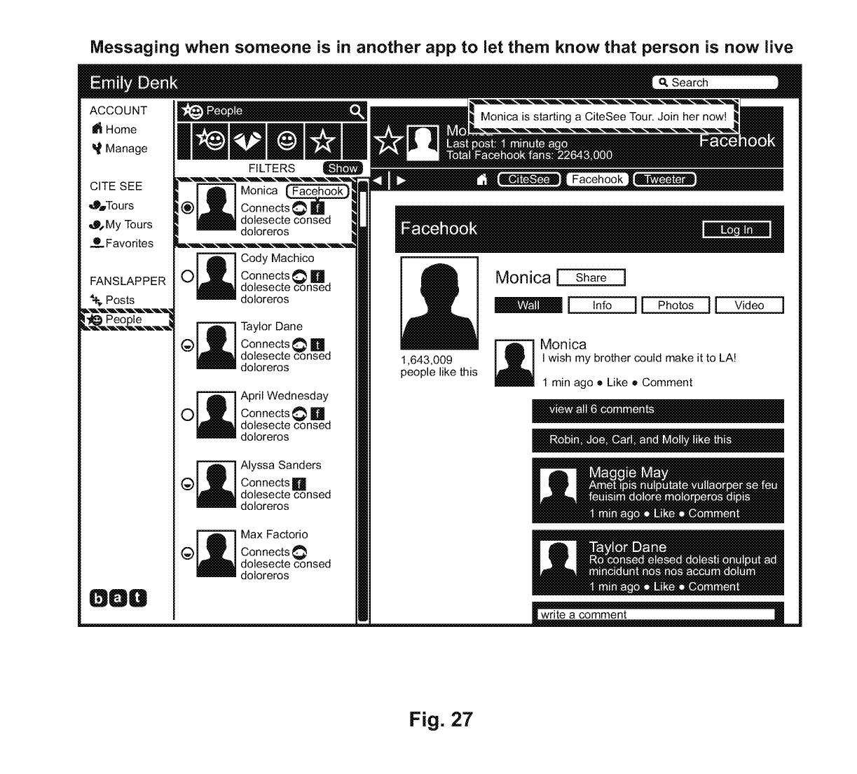

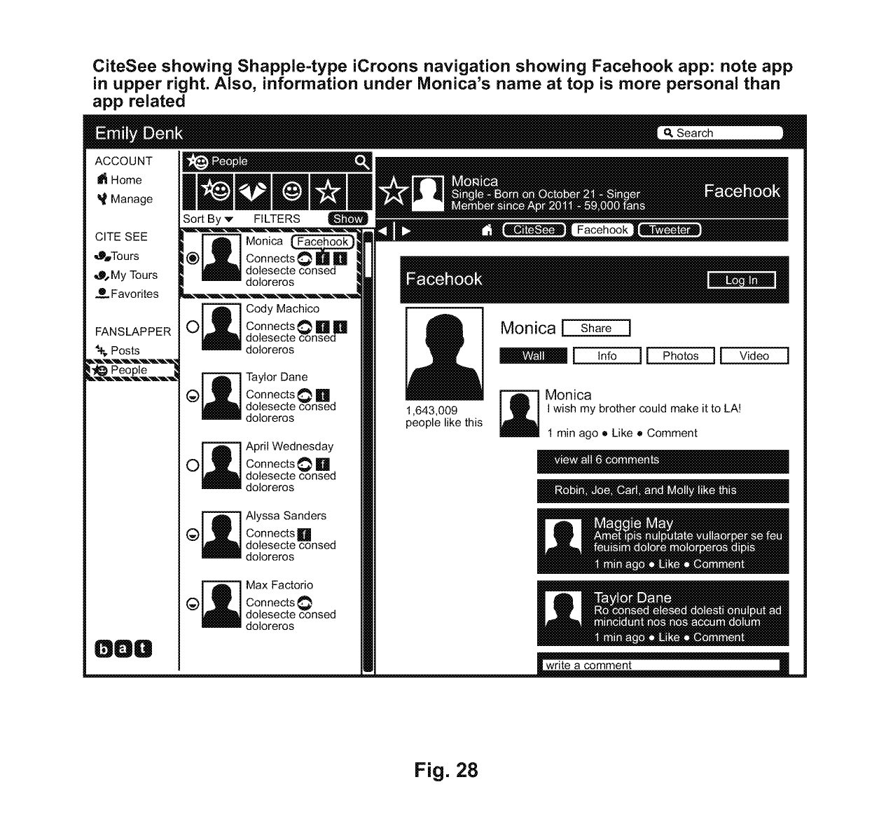

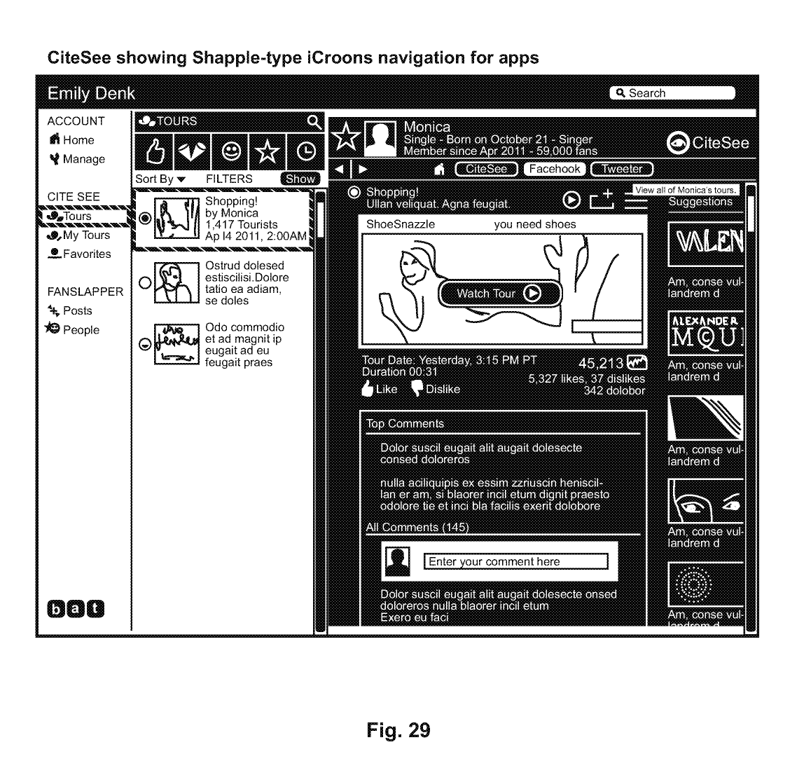

By way of nonlimiting example, FIG. 21 illustrates a navigation wherein a user is engaged in a browsing navigation and/or app use. As illustrated in FIG. 21, the top line interface indicates that Monica, a celebrity, is actively on-line, and access to Monica may indicate to a user browsing activity of Monica, such as is shown in FIG. 21, Facebook commentary from Monica, such as is shown in FIG. 25, or the like. Similarly, FIGS. 22-24 illustrate a navigation of the user through closed and open ones of a variety of applications, which applications may be related to the subject celebrity, in this case, Monica. Likewise, FIGS. 26-28 illustrate the accessing of applications. FIG. 29 illustrates that when a user is using another application, an informational break-in may occur to the in-use application to let the user know that a person of interest is now live on-line, and thus is available for participatory browsing.

Those skilled in the art will appreciate, in light of the disclosure herein, that the present invention is thus highly useful to all parties in the aforementioned widget transaction. For example, the advertiser can obtain new advertising inventory by placement of the enhanced media. By way of further example, the site provider may incur additional rich media that may be placed on the site without cost to the site provider, and that, in fact, may provide additional revenue to the site provider. Such rich media, due to the use of a widget in the present invention, may include the widgetization of desirable content, such as the flipping of Getty images like trading cards, with statistical information on the back of trading card, for example. Finally, the present invention proves useful to the subject of interest in the enhanced media, particularly in embodiments wherein an advertisement for which the subject of interest is an endorser is provided. From the provision of the endorsed advertisement, the subject of interest generates revenue when a user acts on the advertisement.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention.

What is claimed is:

1. A system for providing an image enhancement widget, comprising:
a non-transitory computer readable storage medium having encoded thereon computer executable instructions for providing a javascript component that, upon execution, obtains at least one subject of primary content on a networked page, and at least one permission for enhancement of the primary content;
ones of a plurality of secondary content produced remotely from said javascript component and according to said javascript component;
a flash widget comprising said ones of the plurality of secondary content that is overlayed upon the primary content to provide a permitted one of the enhancement of the primary content on the networked page, without obscuring at least other than the primary content of the networked page.

2. The system of claim 1, wherein the primary content comprises one selected from the group consisting of an image, article, news feed, embedded object, blog, tweet, social network feed and advertisement.

3. The system of claim 1, wherein the secondary content is located proximate to the primary content responsive to a query engine.

4. The system of claim 1, wherein the secondary content is obtained from a vault.

5. The system of claim 1, wherein the javascript component is self updating.

6. The system of claim 1, wherein the obtaining of at least one subject of the primary content by the javascript component further comprises reading a text string header and sending the information read to a remote location.

7. The system of claim 6, wherein the text string header is a xv header and includes at least selected from the group consisting of a image size information, image source information, or textual information.

8. The system of claim 1, wherein the secondary content comprises at least one menu button.

9. The system if claim 1, wherein the primary content is related to a professional athlete and the secondary content provides information about the professional athlete selected from the group consisting of biographic information, background information, sport statistics, and team information.

10. The system of claim 1, wherein the secondary content is selected from the group consisting of social network postings, virtual memorabilia, and a media rating.
